(19) United States
(12) Patent Application Publication
(10) Pub. No.: US 2026/0362232 A1
(43) Pub. Date: Nov. 12, 2026

(54) FIRST NODE, SECOND NODE, FURTHER NODE, COMMUNICATIONS SYSTEM AND METHODS PERFORMED THEREBY FOR HANDLING A SESSION OF A DEVICE FOR AN APPLICATION

(71) Applicant: Telefonaktiebolaget LM Ericsson (publ), Stockholm (SE)

(72) Inventors: Victor GOMEZ-HIDALGO PEREZ, Toledo (ES); Carlota VILLASANTE MARCOS, Madrid (ES); Miguel Angel MUÑOZ DE LA TORRE ALONSO, Madrid (ES)

(21) Appl. No.: 19/153,496

(22) PCT Filed: Feb. 28, 2023
(86) PCT No.: PCT/EP2023/054994

§ 371 Date: Aug. 4, 2025

(30) Foreign Application Priority Data
Feb. 10, 2023 (EP) 23382119.8

(51) Int. Cl. H04W 28/06; H04L 67/141; H04W 76/12

(52) U.S. Cl. CPC H04W 28/06; H04L 67/141; H04W 76/12

(57) ABSTRACT

A computer-implemented method, performed by a first node The method is for handling a session of a device for an application. The first node and the device operate in a communications system. The first node obtains a first indication from, directly or indirectly, a second node operating in the communications system. The first indication comprises first information enabling to identify one or more third nodes operating in the communications system. The one or more third nodes expose services of an operator servicing the session of the device for the application. The operator operates in the communications system. The first node also initiates responsive to the obtained first indication, providing the first information to a further node external to the communications system. The further node services the device in the session for the application.

### TECHNICAL FIELD

The present disclosure relates generally to a first node and methods performed thereby for handling a session of a device for an application. The present disclosure also relates generally to a second node, and methods performed thereby for handling the session of the device for the application. The present disclosure further relates generally to a further node, and methods performed thereby for handling the session of the device the operating in a communications system, for the application. The present disclosure further relates generally to a communications system comprising the first node, the second node and the further node.

### BACKGROUND

Computer systems in a communications network or communications system may comprise one or more nodes. A node may comprise a processing circuitry which, together with computer program code may perform different functions and actions, a memory, a receiving port, and a sending port. A node may be, for example, a server. Nodes may perform their functions entirely on the cloud.

The communications system may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-Universal Terrestrial Radio Access (UTRA), as well as a Fifth Generation (5G) Packet Core Network, which may be referred to as 5G Core Network (5GC), abbreviated as 5GC.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. The AF 1 may allow external parties to use the Exposure Application Program Interfaces (APIs) offered by the Mobile Network Operator (MNO). In case the AF may be trusted, e.g., internal to the network operator, the AF may interact with the 3GPP Core Network directly, with no NEF involved. The NEF 2 may support different functionality, e.g., a set of APIs, e.g., sponsored Data, Quality of Service (QOS), etc., which may allow a content provider to request policies from the MNO, e.g., on a per user session and/or application basis. The NEF 2 may be understood to act as the entry point into the network of the operator, so an external AF, e.g., a content provider, may interact with the 3GPP Core Network through the NEF 2.

A Unified Data Repository (UDR), which is not depicted, may store data grouped into distinct collections of subscription-related information: subscription data, policy data, structured data for exposure, and application data. A Unified Data Management Function (UDM) 3 may generate 3GPP 5G AKA Authentication Vectors, handle user identification handling, support a UE's Serving Network Function (NF) Registration Management, e.g., storing the serving Access and Mobility Function (AMF) for a UE, storing the serving Session Management Function (SMF) for a UE's Protocol Data Unit (PDU) Session, etc., support retrieval of the UE's individual subscription data for slice selection, and handle subscription data for network exposure capabilities applicable to an individual UE or a group of UEs. A Policy Control Function (PCF) 4 may support a unified policy framework to govern the network behavior. Specifically, the PCF 4 may provide Policy and Charging Control (PCC) rules to a Policy and Charging Enforcement Function (PCEF), not depicted in FIG. 1. An SMF 5/User Plane function (UPF) 6 may enforce policy and charging decisions according to provisioned Policy and Charging Control (PCC) rules. The SMF 5 may support different functionalities, e.g., session establishment, modify and release, and policy related functionalities such as termination of interfaces towards policy control functions, charging data collection, support of charging interfaces and control and coordination of charging data collection at the UPF 6. Specifically, the SMF 5 may receive PCC rules from the PCF 4 and configure the UPF 6, e.g., for event reporting, accordingly through an N4 7 reference point, Packet Flow Control Protocol (PFCP) protocol as follows. The SMF 5 may control the packet processing in the UPF 6 by establishing, modifying or deleting PFCP sessions and by provisioning, e.g., adding, modifying or deleting, Packet Detection Rules (PDRs), Forwarding Action Rules (FARs), Quality Enforcement Rules (QERs) and/or Usage Reporting Rules (URRs) per PFCP session, whereby a PFCP session may correspond to an individual PDU session or a standalone PFCP session not tied to any PDU session. Each Packet Data Rule (PDR) may contain a Packet Identifier (PDI) specifying the traffic filters or signatures against which incoming packets may be matched. Each PDR may be associated to the following rules providing the set of instructions to apply to packets matching the PDI: a) one FAR, which may contain instructions related to the processing of the packets, specifically forward, redirect, apply header enrichment, duplicate, drop or buffer the packet with or without notifying the CP function about the arrival of a DL packet, b) zero, one or more QERs, which may contain instructions related to the QoS enforcement of the traffic, and c) zero, one or more URRs, which may contain instructions related to traffic measurement and reporting. 3GPP TS 29.244, v18.0.1 supports an SMF requesting from an UPF to trigger header enrichment through a FAR including a Header Enrichment Information Element (IE). The UPF 6 may support handling of user plane traffic based on the rules received from the SMF 5, specifically, e.g., packet inspection, through PDRs, and different enforcement actions such as, e.g., traffic steering, QoS, charging/reporting, for example through FARs, QERs, and/or URRs. The PCF 4 may provide policy rules to a UE 8 through the AMF 9. The AMF 9 may manage access of the UE 8, for example, when the UE 8 may be connected through different access networks, and mobility aspects of the UE 8. Also depicted in FIG. 1 is a Network Slice Selection Function (NSSF) 10, Network Repository Function (NRF) 11, an Authentication Server Function (AUSF) 12, a Radio Access Network (RAN) 13, and a Data Network (DN) 14. Each of the NSSF 10, the NEF 2, the NRF 11, the PCF 4, the UDM 3, the AF 1, the AUSF 12, the AMF 9, the SMF 5, the UE 8, the RAN 13, the UPF 6 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 6, and the UPF 6 may have an interface N6 27 with the DN 14.

### The Common API Framework (CAPIF)

The CAPIF framework may be understood to allow a content provider, acting as an AF or Application Programming Interface (API) invoker, to request different services offered by an MNO, e.g., through different APIs. FIG. 2 is a schematic diagram illustrating this process.

According to 3GPP TS 23.222, v18.0.0, the CAPIF-1e reference point 21, which may be understood to exist between the API invoker 22 and the CAPIF core function 23, may be used for the API invoker 22 outside the PLMN trust domain 24 to discover service APIs 25, to authenticate and to get authorization. Similarly, the CAPIF-1 reference point 26, which may be understood to exist between an API invoker 27 inside the PLMN trust domain 24 and the CAPIF core function 23, may be used for the API invoker 27 to discover service APIs 25, to authenticate and to get authorization. The CAPIF-2e reference point 28, which may be understood to exist between the API invoker 22 and the service APIs 25 offered by the API provider domain 29, may be used for the API invoker 22 outside the PLMN trust domain 24 to invoke the requested service APIs offered by the MNO (PLMN). Similarly, the CAPIF-2 reference point 30, which may be understood to exist between the API invoker 27 inside the PLMN trust domain 24 and the service APIs 25, may be used for the API invoker 27 inside the PLMN trust domain 24 to invoke the requested service APIs offered by the MNO (PLMN). The CAPIF-3 reference point 31, which may be understood to exist between the API exposing function 32 and the CAPIF core function 23, may be used to. The CAPIF-4 reference point 33, which may be understood to exist between the API publishing function 34 and the CAPIF core function 23, may be used to for exercising access and policy related control for service API communications initiated by the API invoker. The CAPIF-5 reference point 35, which may be understood to exist between the API management function 36 and the CAPIF core function 23, may be used to for publishing the service API information. The CAPIF APIs 37 may be understood to be for management of service API, API invoker and API provider domain function information.

### Traffic Encryption and Content Enrichment

Traffic encryption is growing significantly in mobile networks and at the same time, the encryption mechanisms are growing in complexity. In particular, most applications today are not based on Hypertext Transport Protocol (HTTP) cleartext, but instead they are based on Hyper Text Transfer Protocol Secure (HTTPS) using Transport Layer Security (TLS). Additionally, a significant part of the traffic is based on Quick User Datagram Protocol Internet Connection (QUIC) QUIC transport, which may be understood to have an encryption level higher than TLS.

Based on the encryption trend above, and due to the fact that HTTP Header Enrichment by UPF may only work for traffic in cleartext HTTP, as part of 3GPP Best Practices of PFCP (BEPOP) Study Item, it has been approved a solution where, based on operator policies, the UPF may be instructed by the SMF to insert information as TLS extension(s) in a ClientHello message to an Application Server (AS), when a User Equipment (UE) may initiate a TLS handshake procedure to use HTTPS between the UE and the AS.

Existing methods to handle a session of a UE for an application, such as for example to request different services offered by an MNO, e.g., through different APIs may lead to an ineffective signalling between the entities involved, resulting in high signal overhead and long latencies.

### SUMMARY

As part of the development of embodiments herein, one or more challenges with the existing technology will first be identified and discussed.

According to existing methods, a NEF may expose a set of APIs for third party content/application providers to interact with an operator network. To make use of the APIs provided by the NEF, an AS or AF may need to know which mobile operator network may be being used by a client requesting application resources. As an example, when an AS, e.g., an online film provider, may receive traffic for a certain application, e.g., a film providing session, the AS does not know which MNO, e.g., telecommunications provider A or telecommunications provider B, may be handling that traffic, so it does not know which NEF, e.g., the NEF of telecommunications provider A or the NEF of the telecommunications provider B to contact.

The CAPIF framework may be understood to assume there may be an Service Level Agreement (SLA) between the content provider, that is, the AF, and the MNO, that is, the NEF, so the content provider knows, e.g., as part of the SLA, the address of the MNO entry point, that is, the CAPIF Core Function, through CAPIF-1e. When there is no SLA, this is not possible. One example is a user browsing an example. com site through a browser. It may happen that example. com, acting as AF, may want to trigger Nnef “AS Session with QoS” API in order e.g., to provide high QoS to traffic for the film provider, but does not know which CAPIF Core Function, through CAPIF-1e, and NEF, through CAPIF-2e, instances to contact with in order to, in this example, request the MNO to provide high QoS. Additionally, as mentioned above, the AF does not know which MNO to contact. The Server, that is, the AS/AF, of the film provider, may only be able to see the source Internet Protocol (IP) address from the received packets, which does not identify the MNO, e.g., telecommunications provider A or telecommunications provider B. Hence, if the AS/AF wants to trigger e.g., a Nnef “AS Session with QOS” API, e.g., to provide high QOS to traffic for the film provider, it does not know which MNO's CAPIF Core Function and/or NEF to contact to.

According to the foregoing, there are two problems related to NEF discovery. The first one is for an AF to discover the MNO, e.g., telecommunications provider A. The AF may have locally configured/stored a list of CAPIF Core Functions and NEF on a per MNO basis. In such cases, the AF, just by knowing the MNO, may trigger a request to the CAPIF Core Function of that MNO. The second problem is for the AF to discover the CAPIF Core Function and/or NEF Instances for the discovered MNO in the previous problem, e.g., telecommunications provider A. These problems may be understood to apply both when, there may be no SLA between the content provider and the MNO, and when there may be an SLA between the content provider and the MNO, but the content provider does not know which MNO to contact.

The first scenario, namely, when there may be no SLA between the content provider and the MNO is a relevant scenario as there may be understood to be myriads of content providers and the MNO may not be able to manage having SLAs for all of them. The second scenario, namely, when there may be an SLA between the content provider and the MNO, but the content provider does not know which MNO to contact may be understood to pose a constraint for deploy-ability and applicability of NEF interfaces.

The consequence of the above problems may be understood to be that services provided by the network operators, such as to request the MNO to apply a certain QoS to AF application traffic, e.g., Nnef_AFsessionWithQoS service, to request MNO to sponsor AF application traffic, e.g., Nnef_ChargeableParty service, or to request MNO to route AF application traffic in a certain way, e.g., Nnef_TrafficInfluence service, are not discoverable and usable both by new applications, for which there may be no SLA in place, and by applications for which there may be an SLA in place.

Embodiments herein may be understood to provide a mechanism which may address the above problems and that may be based on defining a new procedure to make one or more nodes internal to a communications system discoverable by a node operating outside the communications system.

According to the foregoing, it is an object of embodiments herein to improve the handling of a session of a device for an application via a communications system.

According to a first aspect of embodiments herein, the object is achieved by a computer-implemented method, performed by a first node. The method is handling a session of a device for an application. The first node and the device operate in the communications system. The first node obtains a first indication from, directly or indirectly, a second node operating in the communications system. The first indication comprises first information enabling to identify one or more third nodes operating in the communications system. The one or more third nodes expose services of an operator servicing the session of the device for the application. The operator operates in the communications system. The first node then initiates, responsive to the obtained first indication, providing the first information to a further node external to the communications system. The further node services the device in the session for the application.

According to a second aspect of embodiments herein, the object is achieved by a computer-implemented method, performed by the second node. The method is for handling the session of the device for the application. The second node and the device operate in the communications system. The second node obtains the first information enabling to identify the one or more third nodes operating in the communications system. The one or more third nodes expose the services of the operator servicing the session of the device for the application. The operator operates in the communications system. The second node also initiates providing, via the first node operating in the communications system, the first information towards the further node external to the communications system. The first node and the further node service the device in the session for the application.

According to a third aspect of embodiments herein, the object is achieved by a computer-implemented method, performed by the further node. The further node is for handling the session of the device operating in the communications system, for the application. The further node is external to the communications system. The further node services the device in the session for the application. The further node obtain the first information from the first node operating in the communications system. The first information enables to identify the one or more third nodes operating in the communications system. The one or more third nodes expose the services of the operator servicing the session of the device for the application. The operator operates in the communications system. The further node then determines, responsive to the obtained first information, the identity of the one or more third nodes. The further node also initiates sending the third request for the service, for the session application, to at least one of the identified one or more third nodes 113.

According to a fourth aspect of embodiments herein, the object is achieved by the first node, for handling the session of the device for the application. The first node and the device are configured to operate in the communications system. The first node is configured to obtain the first indication from, directly or indirectly, the second node configured to operate in the communications system. The first indication is configured to comprise the first information configured to enable to identify the one or more third nodes configured to operate in the communications system. The one or more third nodes are configured to expose the services of the operator being configured to service the session of the device for the application. The operator is configured to operate in the communications system. The first node is also configured to initiate, responsive to the first indication configured to be obtained, providing the first information to the further node external to the communications system. The further node is configured to service the device in the session for the application.

According to a fifth aspect of embodiments herein, the object is achieved by the second node, for handling the session of the device for the application. The second node and the device are configured to operate in the communications system. The second node is configured to obtain the first information configured to enable to identify the one or more third nodes configured to operate in the communications system. The one or more third nodes are configured to expose the services of the operator configured to service the session of the device for the application. The operator is configured to operate in the communications system. The second node is also configured to initiate providing, via the first node configured to operate in the communications system, the first information towards the further node external to the communications system. The first node and the further node are configured to service the device in the session for the application.

According to a sixth aspect of embodiments herein, the object is achieved by the further node, for handling the session of the device configured to operate in the communications system, for the application. The further node is configured to be external to the communications system. The further indication is configured to service the device in the session for the application. The further node is further configured to obtain the first information from the first node configured to operate in the communications system. The first information is configured to enable to identify the one or more third nodes configured to operate in the communications system. The one or more third nodes are configured to expose services of the operator configured to service the session of the device for the application. The operator is configured to operate in the communications system. The further node is also configured to determine, responsive to the first information configured to be obtained, the identity of the one or more third nodes. The further node is additionally configured to initiate sending the third request for the service, for the session application, to at least one of the one or more third nodes configured to be identified.

According to an seventh aspect of embodiments herein, the object is achieved by the communications system comprising the first node, the second node, and the further node.

By obtaining the first indication, the first node may be enabled to initiate providing the first information to the further node.

Since the first information enables to identify the one or more third nodes exposing the services of the operator servicing the session of the device for the application, by initiating providing the first information to the further node, the first node may enable to the further node to contact the one or more third nodes in order to discover which services of the operator servicing the session of the device for the application may be available for the device. Being an external node to the communication system, the further node may otherwise not have other means to obtain this information, or obtain it as readily.

The first node may enable the further node to obtain the first information, in scenarios wherein there may be an SLA between the MNO and the further node, e.g., a provider of content. In this case, the MNO may share all the modifications to the configuration to use the one or more third nodes, e.g., Nnef APIs. This may be understood to provide the flexibility to, for example, move the server hosting the APIs without requiring hardcoded information. Further, the first node may enable the further node to obtain the first information, even in scenarios wherein there may be no SLA between the MNO and the further node. In this case, the MNO may advertise the available services towards the further node and allow the further node to start communicating via the one or more third nodes, e.g., Nnef APIs, to start getting network services. The further node may then in turn be enabled to, not only offer those services to the device, e.g., for the session for the application, but also be enabled to refrain from depending on an existing SLA and/or refrain from having to contact other nodes, which may not service the device, e.g., from other MNOs, to find out what those services may be. For example, the further node may be enabled to identify the one or more third nodes, e.g., a CAPIF Core Function and/or NEF instances, and to trigger an API service request, to for example request a certain QoS for the application traffic.

By obtaining the first information, the second node may be enabled to provide the first information towards the first node.

By initiating providing the first information, the second node may forward, directly or indirectly, the first information retrieved towards the first node. As explained above, the first node may then in turn be enabled to provide the first information to the further node external to the communications system, which may otherwise not have access to this information. This may ultimately enable the fourth node to identify the one or more third nodes exposing the services of the operator servicing the session of the device for the application.

By obtaining the first information from the first node, the further node may then be enabled to determine the identity of the one or more third nodes e.g., the CAPIF Core Function and/or NEF instances, exposing the services of the operator servicing the session of the device for the application. The further node then be further enabled to contact the one or more third nodes, e.g., the NEF, and trigger a request for a service, e.g., an API service request, for example, an AF Session with QOS API. This may be done in a more efficient manner, with less signalling, and lower latency, as the further node may not need to contact nodes, e.g., NEFs, from other operators which may not be servicing the device. Furthermore, the further node may obtain the first information independently of whether there may be an SLA between the MNO and the further node, as explained above.

### BRIEF DESCRIPTION OF THE DRAWINGS

Examples of embodiments herein are described in more detail with reference to the accompanying drawings, according to the following description.

FIG. 1 is a schematic diagram illustrating an example of a 5G Network Architecture, according to existing methods.

FIG. 2 is a schematic diagram illustrating an example of CAPIF interfaces, according to existing methods.

FIG. 3 is a schematic diagram illustrating a non-limiting example of a communications system, according to embodiments herein.

FIG. 4 is a flowchart depicting embodiments of a method in a first node, according to embodiments herein.

FIG. 5 is a flowchart depicting embodiments of a method in a second node, according to embodiments herein.

FIG. 6 is a flowchart depicting embodiments of a method in a further node, according to embodiments herein.

FIG. 7 is a schematic diagram depicting a non-limiting example of signalling between nodes in a communications system, according to embodiments herein.

FIG. 8 is a schematic block diagram illustrating two non-limiting examples, a) and b), of a first node, according to embodiments herein.

FIG. 9 is a schematic block diagram illustrating two non-limiting examples, a) and b), of a second node, according to embodiments herein.

FIG. 10 is a schematic block diagram illustrating two non-limiting examples, a) and b), of a further node, according to embodiments herein.

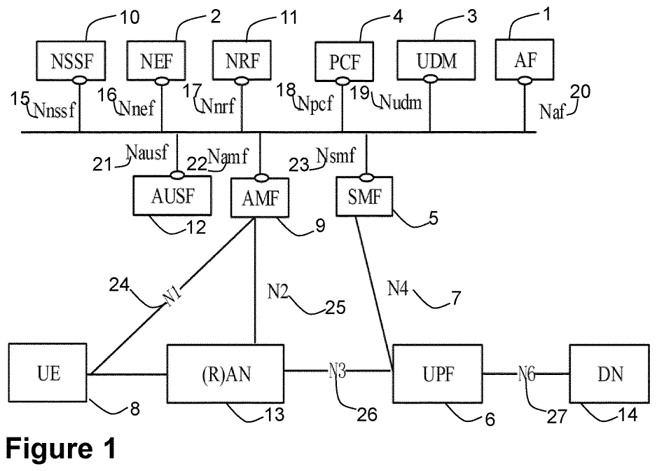

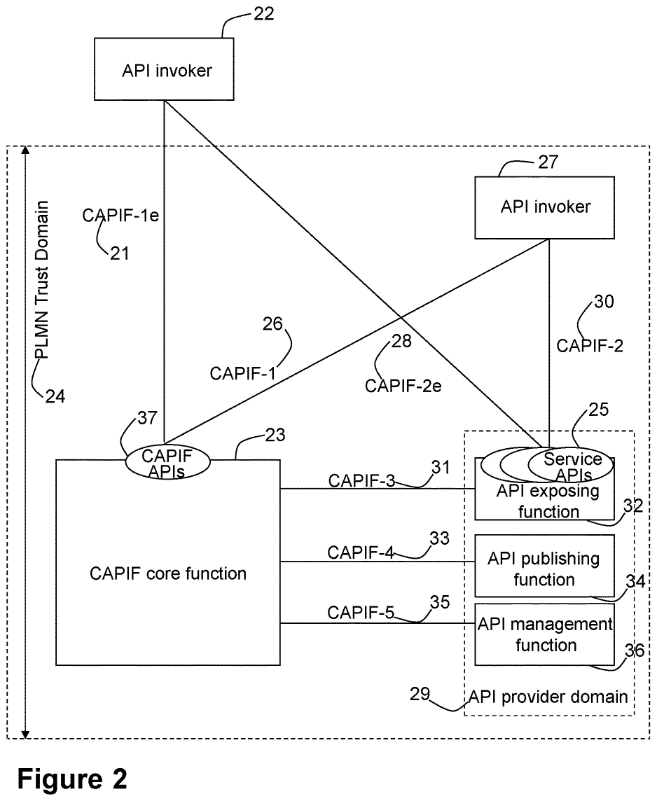

### DETAILED DESCRIPTION

Certain aspects of the present disclosure and their embodiments address one or more of the challenges identified with the existing methods and provide solutions to the challenges discussed.

Embodiments herein may relate to methods for discovery of one or more nodes internal to a communications system by a node external to the communications system. Further particularly, embodiments herein may relate to methods for discovery of MNO, CAPIF Core Function and NEF instances by a node external to the communications system, such as a content provider. Further particular embodiments herein may provide a mechanism which may be understood to address the above problems and may be based on a 5GC control plane instructing a user plane to apply content enrichment, e.g., on a per user's PDU session basis and/or on a per application basis. The content enrichment may be applied with the following parameters: Mobile Network Code (MNC)-Mobile Country Code (MCC), CAPIF Core Function Instance ID, which may be understood to be handling the PDU session of the user, NEF Instance ID, which may be understood to be handling the PDU session of the user and, optionally, the Nnef available APIs for the user's application session.

In summary, embodiments herein may provide a simple mechanism based on content enrichment at a node handing a user plane for a user, e.g., a UPF, as an approach for the AF of a content provider to discover the MNO and information indicating one or more nodes internal to a communications system, e.g., such as the CAPIF Core Function Instance ID and NEF Instance ID, which may be handling a PDU session for a subscriber.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

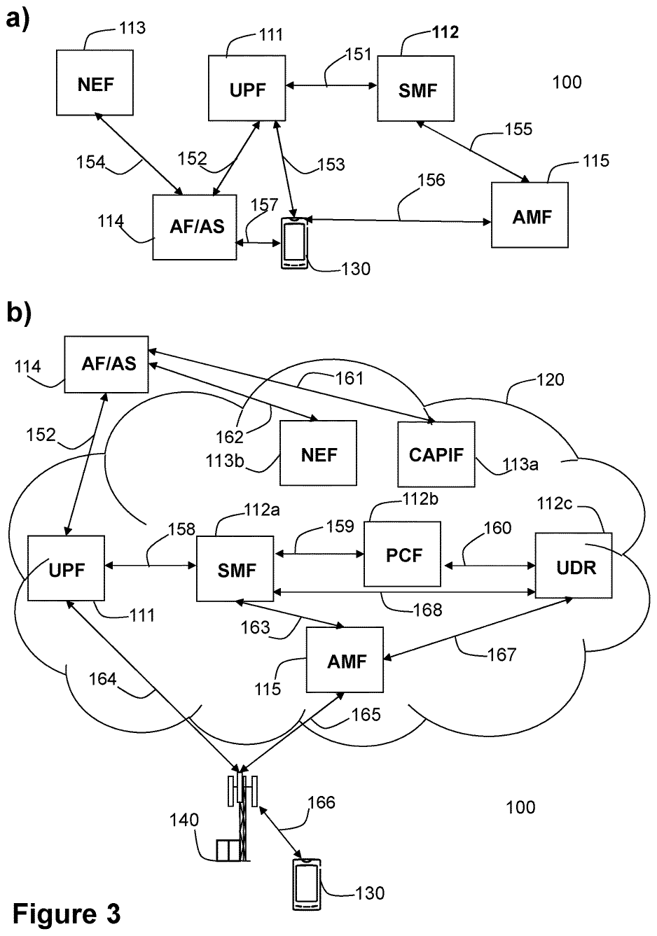

FIG. 3 depicts two non-limiting examples, in panels “a” and “b”, respectively, of a communications system 100, in which embodiments herein may be implemented. In some example implementations, such as that depicted in the non-limiting example of FIG. 3a, the communications system 100 may be a computer network. In other example implementations, such as that depicted in the non-limiting example of FIG. 3b, the communications system 100 may be implemented in a telecommunications system, sometimes also referred to as a telecommunications network, cellular radio system, cellular network, or wireless communications system. In some examples, the telecommunications system may comprise network nodes which may serve receiving nodes, such as wireless devices. The communications system 100 may for example be a network such as a 5G system, or a newer system supporting similar functionality, or a Long-Term Evolution (LTE) network, e.g., LTE Frequency Division Duplex (FDD), LTE Time Division Duplex (TDD), LTE Half-Duplex Frequency Division Duplex (HD-FDD), or LTE operating in an unlicensed band. The communications system 100 may additionally other technologies, such as Wideband Code Division Multiple Access (WCDMA), Universal Mobile Telecommunications System Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, one or more third nodes 113, a further node 114, or fourth node 114, and a fifth node 115 are depicted in FIG. 3. The communications system 100 may comprise, in some examples, as depicted in panel b) of FIG. 3, a first second node 112a, a second second node 112b and a third second node 112c. Similarly, in some examples, as also depicted in panel b) of FIG. 3, the one or more third nodes 113 may comprise a first third node 113a and a second third node 113b. It may be understood that the communications system 100 may comprise more nodes than those represented on FIG. 3, e.g., additional second nodes 112 and additional third nodes 113. The first node 111, the second node 112, e.g., the first second node 112a, the second second node 112b and the third second node 112c, the one or more third nodes 113, e.g., the first third node 113a and the second third node 113b, and the fifth node 115 are comprised in, or are internal to, the communications system 100. The fourth node 114 is external to the communications system 100 but may operate via the communications system 100. In reference to the description of Figure, any reference to the second node 112 may be understood to equally apply to any of the first second node 112a, the second second node 112b and the third second node 112c.

Any of the first node 111, the first second node 112a, the second second node 112b and the fifth node 115 may be referred to as another node 111, 115, 112a, 112b.

Any of the first node 111, the second node 112, the one or more third nodes 113, the fourth node 114 and the fifth node 115 may be understood, respectively, as a first computer system, a second computer system, one or more third computer systems, a fourth computer system and a fifth computer system. In some examples, any of the first node 111, the second node 112, the one or more third nodes 113, the fourth node 114 and the fifth node 115 may be implemented as a standalone server in e.g., a host computer in the cloud 120, as depicted in the non-limiting example depicted in panel b) of FIG. 3. Any of the first node 111, the second node 112, the one or more third nodes 113, the fourth node 114 and the fifth node 115 may in some examples be a distributed node or distributed server, with some of their respective functions being implemented locally, e.g., by a client manager, and some of their functions implemented in the cloud 120, by e.g., a server manager. Yet in other examples, any of the first node 111, the second node 112, the one or more third nodes 113, the fourth node 114 and the fifth node 115 may also be implemented as processing resources in a server farm.

Any of the first node 111, the second node 112, the one or more third nodes 113, and the fifth node 115 may be co-localized.

The first node 111 be understood as a node that may have a capability to handle user plane traffic based on rules, according to embodiments herein. The handling of the traffic may include, for example, packet inspection, e.g., through PDRs, and different enforcement actions such as, e.g., traffic steering, QoS, charging/reporting, for example through FARs, QERs, and/or URRs. The rules may have been received from the second node 112. As depicted in FIG. 3, a non-limiting example of the first node 111, wherein the communications system 100 may be a 5G network, may be a UPF. In other non-limiting examples not depicted in FIG. 3, wherein e.g., the communications system 100 may be a 4G network, the first node 111 may be a Packet Data Network Gateway User plane function (PGW-U), or a Traffic Detection Function User plane (TDF-U).

The second node 112 may be a node having a capability to handle a control plane of a session of a device, such as the device 130 described below, operating in the communications system 100 for an application.

The first second node 112a may a capability to manage a session of a device, such as e.g., the device 130 described below, in the communications system 100, e.g., according to one or more provisioned rules. The first second node 112a may be a node having a capability to enforce policy and charging decisions according to the one or more provisioned rules, e.g., PCC rules. The first second node 112a may support different functionalities, e.g., session establishment, modify and release, and policy related functionalities such as termination of interfaces towards policy control functions, charging data collection, support of charging interfaces and control and coordination of charging data collection at the first node 111. In some examples, the first second node 112a may receive PCC rules from the second second node 112b, and configure the first node 111, e.g., for event reporting, accordingly. The first second node 112a may control the packet processing in the first node 111 by establishing, modifying or deleting PFCP sessions and by provisioning, e.g., adding, modifying or deleting, PDRs, FARs, QERs and/or URRs per PFCP session, whereby a PFCP session may correspond to an individual PDU session or a standalone PFCP session not tied to any PDU session. Each PDR may contain a PDI specifying the traffic filters or signatures against which incoming packets may be matched. Each PDR may be associated to the following rules providing the set of instructions to apply to packets matching the PDI: a) one FAR, which may contain instructions related to the processing of the packets, specifically forward, redirect, apply header enrichment, duplicate, drop or buffer the packet with or without notifying the Control Plane (CP) function about the arrival of a Downlink (DL) packet, b) zero, one or more QERs, which may contain instructions related to the QoS enforcement of the traffic, and c) zero, one or more URRs, which may contain instructions related to traffic measurement and reporting. In specific examples, the first second node 112a may request the first node 111 to trigger header enrichment through a FAR including a Header Enrichment IE. As depicted in FIG. 3, a non-limiting example of the first second node 112a, wherein the communications system 100 may be a 5G network, may be an SMF. In other non-limiting examples not depicted in FIG. 3, wherein e.g., the communications system 100 may be a 4G network, the first second node 112a may be a Packet Data Network Gateway Control plane function (PGW-C), or a Traffic Detection Function Control plane (TDF-C).

The second second node 112b may be a node having a capability to support a unified policy framework to govern network behavior, according to embodiments herein. The second second node 112b may provide policy rules to a device, e.g., the device 130, through the fifth node 115. As depicted in FIG. 3, a particular non-limiting example of the second second node 112b, wherein the communications system 100 may be a 5G network, may be a PCF. In other non-limiting examples not depicted in FIG. 3, wherein e.g., the communications system 100 may be a 4G network, the second second node 112 b may be a Policy and Charging Rule Function (PCRF).

The third second node 112c may be a node having a capability to store data, e.g., grouped into distinct collections of subscription-related information: subscription data, policy data, structured data for exposure, and application data. As depicted in FIG. 3, a particular non-limiting example of the third second node 112c, wherein the communications system 100 may be a 5G network, may be a UDR. In other non-limiting examples not depicted in FIG. 3, wherein e.g., the communications system 100 may be a 4G network, the third second node 112c may be a Subscriber Profile Repository (SPR).

Any of the one or more third nodes 113 may be a node that may have a capability to manage exposure of services of an operator servicing a session of a device, such as the device 130 described below, for an application. That is, for example, any of the one or more third nodes 113 may be a node that may have a capability to manage e.g., different Exposure APIs

The first third node 113a be a node that may have a capability to allow the fifth node 115, e.g., a content provider, acting as an AF or API invoker, to request different services offered by an MNO, e.g., through different APIs. For example, the first third node 113a may be used for the further node 114 outside the trust domain of the communications system 100 to discover service APIs, to authenticate and to get authorization. As depicted in FIG. 3, a particular non-limiting example of the first third node 113a, wherein the communications system 100 may be a 5G network, may be a CAPIF. In other non-limiting examples not depicted in FIG. 3, wherein e.g., the communications system 100 may be a 4G network, the first third node 113a may be a SCEF.

The second third node 113b be a node that may have a capability to support different functionality, e.g., a set of APIs, such as handling e.g., sponsored Data, Quality of Service (QOS), etc., which may allow the further node 114 to request policies from the MNO, e.g., on a per user session and/or application basis. The second third node 113b may be understood to act as the entry point into the communications system 100, so the fourth node 114, e.g., a content provider, may interact with the core network of the communications system 100 through the one or more third nodes 113. As depicted in FIG. 3, a particular non-limiting example of the second third node 113b, wherein the communications system 100 may be a 5G network, may be a NEF. In other non-limiting examples not depicted in FIG. 3, wherein e.g., the communications system 100 may be a 4G network, the second third node 113 b may be a Service Capability Exposure Function (SCEF).

The further node 114 may be a node having a capability to manage service of an application to a device. The further node 114 may interact with the core network of the communications system 100 through the one or more third nodes 113. The further node 114 may allow external parties to use the APIs offered by an MNO of the communications system 100. As depicted in FIG. 3, a particular non-limiting example of the further node 114, wherein the communications system 100 may be a 5G network, may be an AF or AS. In other non-limiting examples not depicted in FIG. 3, wherein e.g., the communications system 100 may be a 4G network, the further node 114 may be a Service Capability Server/Application Server (SCS/AS), such as the device 130 described below.

The fifth node 115 may be a node having a capability to manage access of a device, such as e.g., the device 130 described below, to the communications system 100 when the device may be connected through different access networks, and mobility aspects of the device. As depicted in FIG. 3, a particular non-limiting example of the fifth node 115, wherein the communications system 100 may be a 5G network, may be an AMF. In other non-limiting examples not depicted in FIG. 3, wherein e.g., the communications system 100 may be a 4G network, the fifth node 115 may be a Mobility Management Engine (MME).

The communications system 100 may also comprise a device 130. The device 130 may be also known as e.g., user equipment (UE), a wireless device, mobile terminal, wireless terminal and/or mobile station, mobile telephone, cellular telephone, or laptop with wireless capability, an Internet of Things (IoT) device, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, an Internet of Things (IoT) device, e.g., a sensor or a camera, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 3b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The first node 111 may communicate with the further node 114 over a second link 152, e.g., a radio link or a wired link. The first node 111 may communicate, e.g., indirectly, with the device 130 over a third link 153, e.g., a radio link or a wired link. The third node 113 may communicate with the further node 114 over a fourth link 154, e.g., a radio link or a wired link. The fifth node 115 may communicate with the second node 112, e.g., indirectly, over a fifth link 155, e.g., a radio link or a wired link. The device 130 may communicate with the fifth node 115 over a sixth link 156, e.g., a radio link or a wired link. The further node 114 may communicate with the device 130 over a seventh link 157, e.g., a radio link or a wired link. The first node 111 may communicate with the first second node 112a over an eighth link 158, e.g., a radio link or a wired link. The first second node 112a may communicate with the second second node 112b over a ninth link 159, e.g., a radio link or a wired link. The second second node 112b may communicate with the third second node 112c over a tenth link 160, e.g., a radio link or a wired link. The further node 114 may communicate with the first third node 113a over an eleventh link 161, e.g., a radio link or a wired link. The further node 114 may communicate with the second third node 113b over a twelfth link 162, e.g., a radio link. The first second node 112a may communicate with the fifth node 115 over a thirteenth link 163, e.g., a radio link or a radio link. The first node 111 may communicate with the radio network node 140 over a fourteenth link 164, e.g., a radio link or a wired link. The fifth node 115 may communicate with the radio network node 140 over a fifteenth link 165, e.g., a radio link or a wired link. The radio network node 140 may communicate, directly or indirectly with the device 130 over a sixteenth link 166, e.g., a radio link. The fifth node 115 may communicate with the third second node 112c over a seventeenth link 167, e.g., a radio link or a wired link. The first second node 112a may communicate with the third second node 112c over a eighteenth link 168, e.g., a radio link or a wired link.

Any of the first link 151, the second link 152, the third link 153, the fourth link 154, the fifth link 155, the sixth link 156, the seventh link 157, the eighth link 158, the ninth link 159, the tenth link 160, the eleventh link 161, the twelfth link 162, the thirteenth link 163, fourteenth link 164 and/or the fifteenth link 165 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 3.

Although terminology from Long Term Evolution (LTE)/5G has been used in this disclosure to exemplify the embodiments herein, this should not be seen as limiting the scope of the embodiments herein to only the aforementioned system. Other wireless systems supporting similar or equivalent functionality may also benefit from exploiting the ideas covered within this disclosure.

Embodiments herein may be understood to not only apply to 5G network architecture, but the same mechanisms may be applied to 4G, just by replacing AF by SCS/AS, NEF by SCEF, UDR by SPR, PCF by PCRF, AMF by MME, SMF by PGW-C or TDF-C, and/or UPF by PGW-U or TDF-U.

In some embodiments wherein the communications system 100 may be a 5G system, the first node 111 may be a UPF, the further node 114 may be an AS or an AF, and the second node 112 may be a node handling a control plane of the session. The second node 112 may be at least one of: i) an SMF, ii) a PCF, and iii) a UDR.

In some embodiments wherein the communications system 100 may be a 4G system, the first node 111 may be a PGW-U or a TDF-U, the further node 114 may be an AS or an SCS, and the second node 112 may be a node handling a control plane of the session. The second node 112 may be at least one of: i) a PGW-C or a TDF-C, ii) a PCRF, and iii) an SPR.

In future telecommunication networks, e.g., in the sixth generation (6G), the terms used herein may need to be reinterpreted in view of possible terminology changes in future technologies. In general, the usage of “first”, “second”, “third”, “fourth”, “fifth”, “sixth”, “seventh”, “eighth”, “ninth”, “tenth”, “eleventh”, “twelfth”, “thirteenth”, or “fourteenth”, “fifteenth”, “sixteenth”, “seventeenth” and/or “eighteenth” herein may be understood to be an arbitrary way to denote different elements or entities and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

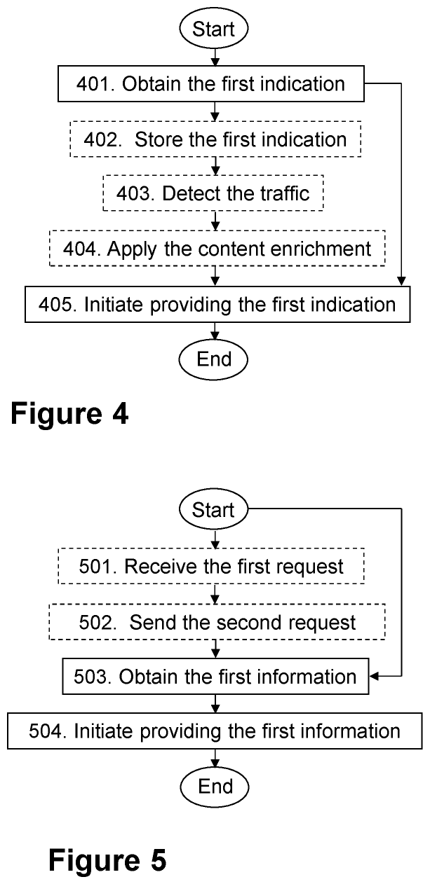

Embodiments of a computer-implemented method, performed by the first node 111, will now be described with reference to the flowchart depicted in FIG. 4. The method may be understood to be for handling a session of the device 130 for an application. The first node 111 and the device 130 operate in the communications system 100.

Several embodiments are comprised herein. In some embodiments, all the actions may be performed. In some embodiments, two or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first node 111 is depicted in FIG. 4.

In FIG. 4, optional actions are represented with dashed lines.

### Action 401

In this Action 401, the first node 111 obtains a first indication from, directly or indirectly, the second node 112. The second node 112 operates in the communications system 100. The second node 112 may be a node in the control plane, e.g., 5GC Control Plane, of the communications system 100. The first node 111 may be a node in the User Plane.

Obtaining may comprise receiving, e.g., via the first link 151.

In some of these embodiments, the first indication may be obtained in this Action 401, at PDU session establishment, and during the PDU session for updates.

The first indication comprises first information enabling to identify the one or more third nodes 113 operating in the communications system 100. The one or more third nodes 113 expose services of an operator servicing the session of the device 130 for the application. The operator operates in the communications system 100. The operator may be understood as, e.g., an MNO.

In some embodiments, the first information may comprise at least one of the following options. According to a first option, the first information may comprise a first identifier of the operator. In some embodiments, the first identifier may be a Mobile Network Code-Mobile Country Code (MNC-MCC). The first identifier may be used to identify the MNO.

According to a second option, the first information may comprise a second identifier of the first third node 113a of the one or more third nodes 113. The first third node 113a may be a CAPIF core function for the session. In some embodiments, the second identifier may be a first address of a CAPIF Core Function Instance. The second identifier may, in such embodiments, be understood to be CAPIF core function address Information. This may be e.g., a domain name, server name or host name, or an IP address which may allow to identify the CAPIF Core Function instance handling the PDU session of a user of the device 130.

According to a third option, the first information may comprise a third identifier of the second third node 113b of the one or more third nodes 113. The second third node 113b may be one of: i) a NEF instance handling the session, and ii) a SCEF instance handling the session. In some embodiments, the third identifier may be a second address of the NEF Instance. The third identifier may, in the first case, be understood to be NEF Address information. This may be e.g., a domain name, server name or host name, or an IP address which may allow to identify the NEF instance handling the PDU session of the user of the device 130.

According to a fourth option, the first information may comprise one or more respective fourth identifiers of available APIs for the session. In some embodiments, the one or more respective fourth identifiers may comprise a list of Nnef available APIs. For example, a list of Nnef available APIs for the PDU session of the user of the device 130, on a per application basis. The list of Nnef available APIs may be, e.g., List of (App-ID, allowed Nnef APIs). For example, for App-ID=example. com, the following services may be allowed for the subscriber. A first service may be a QoS service, e.g., Nnef_AFsessionWithQoS service, so a Content Provider may be allowed to request a certain QoS for the application. A second service may be a sponsoring service, e.g., a Nnef_ChargeableParty service, so the application data may be allowed to be sponsored by a third party, e.g., a Content provider. In some examples, in order to support dynamic SLA creation, when, for example, there may be no explicit SLA between the MNO and the Content Provider, there may be provisioned a list of default Nnef APIs for applications which may be unknown to the MNO, e.g., App-ID=default. In this case, it the Content Provider may provide the detection rules for those application/s to the MNO.

In particular embodiments, the first information may comprise one of: a) the first identifier and the second identifier, and b) the first identifier and the third identifier.

It may be assumed, as a precondition, that the first information may have been stored e.g., at the second node 112, for example, the third second node 112c, e.g., a UDR.

Further particularly, it may be understood to be a first precondition in some embodiments, that the MNO has stored the list of CAPIF Core Function and NEF instances. It may be assumed this information may be stored in the third second node 112c, e.g., the UDR.

In some embodiments, it may be understood to be a second precondition that the MNO has stored the list of available NEF APIs, services, instances. It may be assumed this information may be stored in the third second node 112c, e.g., the UDR.

In some embodiments, it may be understood to be a third precondition that the MNO has stored the list of allowed services both on a per application basis and subscriber basis. It may be assumed this information may be stored in the third second node 112c, e.g., the UDR, as subscriber data.

In some embodiments, the first indication may be a PFCP Session Establishment Request.

In some embodiments, the first indication may further comprise a further indication instructing the first node 111 to perform applying of content enrichment, as will be described in Action 404.

In some embodiments, the further indication may be a FAR.

In some examples, the further indication may instruct the first node 111 to perform the applying of content enrichment on a per user's PDU session basis and/or on a per application basis.

In some embodiments, the further indication may comprise the one or more respective fourth identifiers and a fifth identifier identifying the application to which the session may belong.

By obtaining the first indication in this Action 401, the first node 111 may then be enabled to initiate providing the first information to the further node 114, which being an external node to the communication system 100 may otherwise not have other means to obtain it or obtain it as readily. The further node 114 may ultimately, by obtaining the first information, be enabled to contact the one or more third nodes 113 to know which services of the operator servicing the session of the device 130 for the application may be available for the device 130. The further node 114 may in turn be enabled then to, not only offer those services to the device 130, e.g., for the session for the application, but also be enabled to refrain from depending on an existing SLA and/or refrain from having to contact other nodes, which may not service the device 130, e.g., from other MNOs, to find out what those services may be.

### Action 402

In this Action 402, the first node 111 may store the obtained first information. The first node 111 may store the obtained first information in a memory of the first node 111.

By the first node 111 storing the obtained first information in this Action 402, the first node 111 may be able to retrieve the first information and initiate providing it to the fourth node 114 of the device 130, as described in the next actions.

### Action 403

In some embodiments, in this Action 403, the first node 111 may detect, after having received the first indication, traffic from the device 130, by receiving a second indication from the device 130. The first node 111 may detect the second indication, for example, when the device 130 may open the application, e.g., example. com.

The second indication may be, for example, a first TLS message. The first TLS message may be a first client Hello message.

By detecting the second indication in this Action 403, the first node 111 may be then be enabled to apply content enrichment to the second indication, e.g., according to the instruction provided in the further indication, as will be described in the next Action 404, so that the further node 114 may ultimately obtain the first information.

### Action 404

In some embodiments, in this Action 404, the first node 111 may apply content enrichment to the received second indication with the first information obtained in Action 401. The application of the content enrichment in this Action 404 may be according to the instruction provided in the further indication.

In some examples, the first node 111 may enrich the second indication, that is, application traffic, e.g., TLS Client Hello, with the first identifier, e.g., MCC-MNC, to identify the MNO, and the second identifier, e.g., the CAPIF Core Function address information, so the further node 114 may be able to then contact the corresponding one or more third nodes 113, e.g., the CAPIF Core Function instance to retrieve more information about the available Nnef APIs for the user and application session.

In some examples, the first node 111 may enrich the second indication, that is, the application traffic, e.g., TLS Client Hello, with the first identifier, e.g., MCC-MNC, to identify the MNO, the third identifier, e.g., the NEF address information, and the one or more respective fourth identifiers, e.g., the list of available Nnef APIs for the user and application session. This may be understood to be the fastest procedure which may allow the further node 114 to directly contact the corresponding NEF instance to invoke the service API/s, e.g., AF session with QoS.

Yet in some examples, the first node 111 may enrich the second indication, that is, application traffic, e.g., TLS Client Hello, with the first identifier, e.g., MCC-MNC, the second identifier, e.g., the CAPIF Core Function address information, the third identifier, e.g., the NEF address information, and the one or more respective fourth identifiers, e.g., the allowed services for App-ID=example. com, e.g., Nnef_ChargeableParty service and Nnef_AFsessionWithQoS service.

By applying the content enrichment in this Action 404, the first node 111 may be enabled to then initiate providing the first information to the further node 114 in the next Action 405. The further node 114 may ultimately, by obtaining the first information, be enabled to contact the one or more third nodes 113 to know which services of the operator servicing the session of the device 130 for the application may be available for the device 130. For example, the further node 114 may be enabled to identify the one or more third nodes 113, e.g., the CAPIF Core Function and/or NEF instances, and to trigger an API service request, e.g., AF Session with QOS API, to for example request a certain QoS for the application traffic. The further node 114 may in turn be enabled then to, not only offer those services to the device 130, e.g., for the session for the application, but also be enabled to refrain from depending on an existing SLA and/or refrain from having to contact other nodes, which may not service the device 130, e.g., from other MNOs, to find out what those services may be.

### Action 405

In this Action 405, the first node 111 initiates, responsive to the obtained first indication, providing the first information to the further node 114 external to the communications system 100. The further node 114 services the device 130 in the session for the application.

Initiating may be understood as triggering, starting, facilitating or enabling.

The initiating providing in this Action 405 may comprise providing the stored first information, from Action 404, to the further node 114.

The initiating providing in this Action 405 may comprise sending a third indication comprising the second indication with the applied content enrichment.

In some embodiments, the second indication may be, for example, a first TLS message, and the third indication is a second TLS message.

In some embodiments, the first TLS message may be a first client Hello message and the second TLS message may be a second client Hello message.

The initiating providing, e.g., sending, in this Action 405 may be performed e.g., via the fourth link 154.

By initiating providing the first information to the further node 114 in this Action 405, the first node 111 may enable the further node 114 to contact the one or more third nodes 113 to know which services of the operator servicing the session of the device 130 for the application may be available for the device 130. For example, the further node 114 may be enabled to identify the one or more third nodes 113, e.g., the CAPIF Core Function and/or NEF instances, and to trigger an API service request, to for example request a certain QoS for the application traffic. The first node 111 may enable the further node 114 to obtain the first information, in scenarios wherein there may be an SLA between the MNO and the further node 114, e.g., Content Provider. In this case, the MNO may share all the modifications to the configuration to use the one or more third nodes 113, e.g., Nnef APIs. This may be understood to provide the flexibility to, for example, move the server hosting the APIs without requiring hardcoded information. Further, the first node 111 may enable the further node 114 to obtain the first information, even in scenarios wherein there may be no SLA between the MNO and the further node 114, e.g., Content Provider. In this case, the MNO may advertise the available services towards the further node 114 and allow the further node 114 to start communicating via the one or more third nodes 113, e.g., Nnef APIs, to start getting network services.

The further node 114 may in turn be enabled then to, not only offer those services to the device 130, e.g., for the session for the application, but also be enabled to refrain from depending on an existing SLA and/or refrain from having to contact other nodes, which may not service the device 130, e.g., from other MNOs, to find out what those services may be.

Embodiments of a computer-implemented method performed by the second node 112, will now be described with reference to the flowchart depicted in FIG. 5. The method may be understood to be for handling the session of the device for the application. The second node 112 operates via the communications system 100.

The method may comprise the following actions. Several embodiments are comprised herein. In some embodiments, the method may comprise all the actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 5, optional actions are depicted with dashed lines.

The detailed description of some of the following corresponds to the same references provided above, in relation to the actions described for the first node 111 and will thus not be repeated here to simplify the description. For example, in some embodiments, the second node 112 may be a node in the control plane, e.g., 5GC Control Plane, of the communications system 100. The first node 111 may be a node in the User Plane.

### Action 501

In this Action 501, the second node 112 may receive a first request from another node 111, 115, 112a, 112b.

The receiving in this Action 501 may be performed e.g., via the first link 151, the fifth link 155, or the ninth link 159.

The characteristics of this Action 501 may be based on the type of node the second node 112 may be, and are described below as Action 501a for embodiments wherein the second node 112 may be the first second node 112a, Action 501b for embodiments wherein the second node 112 may be the second second node 112b and Action 501c for embodiments wherein the second node 112 may be the third second node 112c.

### Action 501a

In some embodiments, the second node 112 may be the first second node 112a. In some of such embodiments, and at least one of the following options may apply. The first second node 112a may be an SMF. The first request may be a first first request received from the fifth node 115 operating in the communication system 100. The fifth node 115 may be an AMF. The first first request may be to establish the session for the device 130. The first first request may comprise an identifier of the device 130, e.g., UE-ID. The first first request may be an Nsmf PDU Session Create Request. The receiving of the first first request may be a result of the device 130 triggering a PDU Session Establishment procedure.

### Action 501b

In some embodiments, the second node 112 may be the second second node 112b. In some of such embodiments, and at least one of the following options may apply. The second second node 112b may be an PCF. The first request may be a second first request received from the first second node 112a. The first second node 112a may be an SMF. The second first request may be for a policy control for the session. The second first request may comprise the identifier of the device 130. The second first request may be an Npcf_SMPolicyControl_Create Request. The second first request may comprise the identifier of the device 130, e.g., UE-ID. The receiving of the second first request may be a result of the device 130 triggering the PDU Session Establishment procedure.

### Action 501c

In some embodiments, the second node 112 may be the third second node 112c. In some of such embodiments, and at least one of the following options may apply. The third second second node 112c may be a UDR. The first request may be a third first request received from the second second node 112b. The second second node 112b may be a PCF. The third first request may be for subscriber data for the device 130. The third first request may comprise the identifier of the device 130. The third first request may be a Nudr_Query Request.

By receiving the first request from the another node 111, 115, 112a, 112b, the second node 112 may trigger the retrieval of the first information, as will be explained in the next actions, thereby enabling to identify the one or more third nodes 113 exposing the services of the operator servicing the session of the device 130 for the application. The first information may then be enabled to be stored at the first node 111 and provided to the further node 114 external to the communications system 100, which may otherwise not have access to this information.

### Action 502

In this Action 502, the second node 112 may send, based on the received first request, a second request. The second request may be to obtain, directly or indirectly, the first information. The first information may be understood to enable to identify the one or more third nodes 113 operating in the communications system 100. The one or more third nodes 113 may be understood to expose services of the operator servicing the session of the device 130 for the application. The operator may be understood to be operating in the communications system 100.

The type of the second request may depend on the identity of the second node 112, as follows.

The characteristics of this Action 502 may be based on the type of node the second node 112 may be and are described below as Action 502a for embodiments wherein the second node 112 may be the first second node 112a, Action 502b for embodiments wherein the second node 112 may be the second second node 112b and Action 502c for embodiments wherein the second node 112 may be the third second node 112c.

### Action 502a

In some embodiments, the second node 112 may be the first second node 112a. In some of such embodiments, and at least one of the following options may apply. The second request may be a first second request sent to the second second node 112b. The second second node 112b may be a PCF. The first second request may be an Npcf_SMPolicyControl_Create Request. The sending of the first second request may be a result of the device 130 triggering the PDU Session Establishment procedure. The first second request may comprise the identifier of the device 130, e.g., UE-ID.

### Action 502b

In some embodiments, the second node 112 may be the second second node 112b. In some of such embodiments, and at least one of the following options may apply. The second request may be a second second request sent to the third second node 112c. The third second node 112c may be a UDR. The second second request may be a Nudr_Query Request. The first second second request may comprise the identifier of the device 130, e.g., UE-ID.

### Action 502c

In some embodiments, the second node 112 may be the third second node 112c. In some of such embodiments, and at least one of the following options may apply. The second request may be a third second request to a storage managed by the third second node 112c.

By sending the second request in this Action 502, the second node 112 may be enabled to directly or indirectly, ultimately request the retrieval of the first information, e.g., the session and subscriber data for the identified device 130, e.g., the indicated UE-ID, as will be explained in the next actions. When requesting the retrieval of the first information indirectly, the second node 112 may forward the request to an intermediate node between the second node 112 sending the second request, and the memory wherein the first information may be stored. The second node 112, by requesting the retrieval of the first information may thereby enable to identify the one or more third nodes 113 exposing the services of the operator servicing the session of the device 130 for the application. The first information may then be enabled to be stored at the first node 111 and provided to the further node 114 external to the communications system 100, which may otherwise not have access to this information.

### Action 503

In this Action 503, the second node 112 obtains the first information enabling to identify the one or more third nodes 113 operating in the communications system 100. The one or more third nodes 113 expose services of the operator servicing the session of the device 130 for the application. The operator operates in the communications system 100.

The obtaining in this Action 503 of the first information is obtained in a first response to the sent second request in Action 502.

The first request received in Action 501 may therefore trigger the obtaining in this Action 503 of the first information.

In some embodiments, the first information may comprise at least one of the following options. According to a first option, the first information may comprise the first identifier of the operator. In some embodiments, the first identifier may be an MNC-MCC.

According to a second option, the first information may comprise the second identifier of the first third node 113a of the one or more third nodes 113. The first third node 113a may be a CAPIF core function for the session. In some embodiments, the second identifier may be the first address of the CAPIF Core Function Instance.

According to a third option, the first information may comprise the third identifier of the second third node 113b of the one or more third nodes 113. The second third node 113b may be one of: i) the NEF instance handling the session, and ii) the SCEF instance handling the session. In some embodiments, the third identifier may be the second address of the NEF Instance.

According to a fourth option, the first information may comprise the one or more respective fourth identifiers of available APIs for the session. In some embodiments, the one or more respective fourth identifiers may comprise the list of Nnef available APIs.

In some embodiments, the first information may comprise one of: a) the first identifier and the second identifier, and b) the first identifier and the third identifier.

According to the foregoing, the first information, e.g., session and subscriber data for the device 130, may be extended with the following parameters: the first identifier, e. g, MCC-MNC, the second identifier, e.g., the first address of the CAPIF Core Function instance, the third identifier, e.g., the second address of the NEF instance, and the one or more respective fourth identifiers, e.g., the list of allowed Nnef APIs. In some examples of embodiments herein, the N7 interface may be extended, e. g, to carry the second identifier, e.g., the CAPIF Core Function address information, the third identifier, e.g., the NEF address information, and by extending the PCC rule to include the one or more respective fourth identifiers, e.g., the allowed Nnef APIs, on a per application basis.

The characteristics of this Action 503 may be based on the type of node the second node 112 may be and are described below as Action 503a for embodiments wherein the second node 112 may be the first second node 112a, Action 503b for embodiments wherein the second node 112 may be the second second node 112b and Action 503c for embodiments wherein the second node 112 may be the third second node 112c.

### Action 503a

In some embodiments, the second node 112 may be the first second node 112a. In some of such embodiments, and at least one of the following options may apply. The first response may be a first first response from the second second node 112b. The first first response may be an Npcf_SMPolicyControl_Create Response.

### Action 503b

In some embodiments, the second node 112 may be the second second node 112b. In some of such embodiments, and at least one of the following options may apply. The first response may be a second first response from the third second node 112c. The second first response may be a Nudr_Query Response.

### Action 503c

In some embodiments, the second node 112 may be the third second node 112c. In some of such embodiments, and at least one of the following options may apply. The first response may be a third first response from the storage.

By performing this Action 503, the second node 112 may be enabled to obtain the first information, directly or indirectly, e.g., as session and subscriber data for the device 130. The second node 112 may then be enabled to provide the first information towards the first node 111. The first node 111 may in turn be enabled to be store the first information at the first node 111 and provide it to the further node 114 external to the communications system 100, which may otherwise not have access to this information. This may ultimately enable the fourth node 114 to identify the one or more third nodes 113 exposing the services of the operator servicing the session of the device 130 for the application.

### Action 504

In this Action 504, the second node 112 may initiate providing, via the first node 111 operating in the communications system 100, the first information towards the further node 114. The further node 114 is external to the communications system 100. The first node 111 and the further node 114 service the device 130 in the session for the application.

As stated earlier, in some embodiments wherein the communications system 100 may be a 5G system, the first node 111 may be a UPF, the further node 114 may be an AS or an AF, and the second node 112 may be a node handling the control plane of the session. The second node 112 may be at least one of: i) an SMF, ii) a PCF, and iii) a UDR.

In some examples of embodiments herein, the N4 interface may be extended, e. g, to carry the second identifier, e.g., the CAPIF Core Function address information, the third identifier, e.g., the NEF address information, and by indicating in the FAR the content enrichment action with the one or more respective fourth identifiers, e.g., the allowed Nnef APIs, on a per application basis.

In some embodiments wherein the communications system 100 may be a 4G system, the first node 111 may be a PGW-U or a TDF-U, the further node 114 may be an AS or an SCS, and the second node 112 may be a node handling the control plane of the session. The second node 112 may be at least one of: i) a PGW-C or a TDF-C, ii) a PCRF, and iii) an SPR.

The characteristics of this Action 504 may be based on the type of node the second node 112 may be, and are described below as Action 504a for embodiments wherein the second node 112 may be the first second node 112a, Action 504b for embodiments wherein the second node 112 may be the second second node 112b and Action 504c for embodiments wherein the second node 112 may be the third second node 112c.

### Action 504a

In some embodiments, the second node 112 may be the first second node 112a. In some of such embodiments, and at least one of the following options may apply. The first request may be the first first request received from the fifth node 115 operating in the communication system 100. The first first request may be to establish the session for the device 130. The first first request may comprise the identifier of the device 130. The first second node 112a may be an SMF. The fifth node 115 may be an AMF. The first first request may be the Nsmf PDU Session Create Request. The second request may be the first second request sent to the second second node 112b. According to an eighth option, the second second node 112b may be a PCF. The first second request may be the Npcf_SMPolicyControl_Create Request. The first response may be the first first response from the second second node 112b. The first first response may be the Npcf_SMPolicyControl_Create Response. The first node 111 may be a UPF. The initiating providing in this Action 504 may comprise sending the first information to the first node 111 in the first indication. The first indication may be the PFCP Session Establishment Request. The first indication may further comprise the further indication instructing the first node 111 to apply content enrichment to the second indication received from the device 130. The further indication may be a FAR. The second indication may be the first TLS, message. The first TLS message may be the first client Hello message.

### Action 504b

In some embodiments, the second node 112 may be the second second node 112b. In some of such embodiments, and at least one of the following options may apply. The first request may be the second first request received from the first second node 112a. The second first request may be for the policy control for the session. The second first request may comprise the identifier of the device 130. The second second node 112b may be a PCF. The first second node 112a may be an SMF. The second first request may be the Npcf_SMPolicyControl_Create Request. The second request may be the second second request sent to the third second node 112c. The third second node 112c may be a UDR. The second second request may be the Nudr_Query Request. The first response may be the second first response from the third second node 112c. The second first response may be the Nudr_Query Response. The first node 111 may be a UPF. The initiating providing in this Action 504 may comprise sending the first information to the first second node 112a in a first second response. The second response may be an Npcf_SMPolicyControl_Create Response.

### Action 504c

In some embodiments, the second node 112 may be the third second node 112c. In some of such embodiments, and at least one of the following options may apply. The first request may be the third first request received from the second second node 112b. The third first request may be for subscriber data for the device 130. The third first request may comprise the identifier of the device 130. The third second second node 112c may be a UDR. The second second node 112b may be a PCF. The third first request may be the Nudr_Query Request. The second request may be the third second request to the storage managed by the third second node 112c. The first response may be the third first response from the storage. The first node 111 may be a UPF. The initiating providing in this Action 504 may comprise sending the first information to the second second node 112b in a second second response. The second second response may be a Nudr_Query Response.

By initiating providing the first information in this Action 504a, the second node 112 may forward, directly or indirectly, the information retrieved in Action 503 towards the first node 111. As explained earlier, the first node 111 may in turn be enabled to store the first information at the first node 111 and later provide it to the further node 114 external to the communications system 100, which may otherwise not have access to this information. This may ultimately enable the fourth node 114 to identify the one or more third nodes 113 exposing the services of the operator servicing the session of the device 130 for the application.

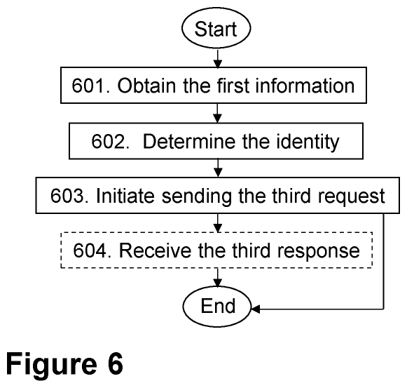

Embodiments of a computer-implemented method performed by the further node 114, will now be described with reference to the flowchart depicted in FIG. 6. The method may be understood to be for handling the session of the device operating in the communications system 100, for the application. The further node 114 is external to the communications system 100 and the further node 114 services the device 130 in the session for the application.

The method may comprise the following actions. Several embodiments are comprised herein. In some embodiments, the method may comprise all the actions. In other embodiments, the method may comprise three or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 6, optional actions are depicted with dashed lines.

The detailed description of some of the following corresponds to the same references provided above, in relation to the actions described for the first node 111 and will thus not be repeated here to simplify the description. For example, in some embodiments, the first node 111 may be a node in the User Plane.

### Action 601

In this Action 601, the further node 114 obtains the first information from the first node 111 operating in the communications system 100. The first information enables to identify the one or more third nodes 113 operating in the communications system 100. The one or more third nodes 113 expose the services of the operator servicing the session of the device 130 for the application. The operator operates in the communications system 100.

The obtaining, e.g., receiving, in this Action 601 may be performed, e.g., via the second link 152.

The obtaining in this Action 601 of the first information may comprise receiving the third indication comprising the second indication with content enrichment.

The second indication may be the first TLS message, and the third indication may be a second TLS message. The first TLS message may be the first client Hello message and the second TLS message is the second client Hello message.

As stated earlier, in some embodiments wherein the communications system 100 may be a 5G system, the first node 111 may be a UPF, and the further node 114 may be an AS or an AF.

In some embodiments wherein the communications system 100 may be a 4G system, the first node 111 may be a PGW-U or a TDF-U, and the further node 114 may be an AS or an SCS.

In some embodiments, the first information may comprise at least one of the following options. According to a first option, the first information may comprise the first identifier of the operator.

According to a second option, the first information may comprise the second identifier of the first third node 113a of the one or more third nodes 113. The first third node 113a may be the CAPIF core function for the session.

According to a third option, the first information may comprise the third identifier of the second third node 113b of the one or more third nodes 113. The second third node 113b may be one of: i) the NEF instance handling the session, and ii) the SCEF instance handling the session.

According to a fourth option, the first information may comprise the one or more respective fourth identifiers of available APIs for the session.

In some embodiments, at least one of the following may apply. In some embodiments, the first identifier may be an MNC-MCC. In some embodiments, the second identifier may be the first address of the CAPIF Core Function Instance. In some embodiments, the third identifier may be the second address of the NEF Instance. In some embodiments, the one or more respective fourth identifiers may comprise the list of Nnef available APIs.

In some embodiments, the first information may comprise one of: a) the first identifier and the second identifier, and b) the first identifier and the third identifier.

### Action 602

The further node 114, in this Action 602, determines, responsive to the obtained first information, an identity of the one or more third nodes 113.

The determining in Action 602 of the identity may comprise extracting the content enrichment from the third indication. The further node 114, e.g., the AS/AF of a provider or content, may extract the enriched information and use it to identify the one o more third nodes 113. For example, the first identifier, e.g., MCC-MNC may allow the further node 114 to identify from which MNO it may receive application session traffic. The further node 114 may then retrieve, from the second identifier and third identifier, the information on which MNO's CAPIF Core Function and NEF instances, respectively, may be handling the session of the user of the device 130, and information on which Nnef APIs may be available for the application traffic.

By determining the identity of the one or more third nodes 113 in this Action 602,, e.g., the CAPIF Core Function and/or NEF instances, the further node 114 may be further enabled to trigger a third request for a service, e.g., an API service request, for example, an AF Session with QOS API. The further node 114 may then be further enabled to contact the one or more third nodes 113, e.g., the NEF, and trigger the selected API/s, e.g., Nnef API/s.

### Action 603

In this Action 603, the further node 114 initiates sending a third request for a service, for the session application, to at least one of the identified one or more third nodes 113. The third request for the service, e.g., the API service request, may be, for example, an AF Session with QOS API.

As an example, in this Action 603, the further node 114 may use the third identifier, e.g., the NEF address information, to identify the NEF instance and trigger the API service request to request a certain QoS for the application traffic through Nnef_AFSessionWithQOS API, by including the following information: a sixth identifier of the further node 114, AF-ID, the fifth identifier of the application to which the session belongs, e.g., App-ID=example. com, the third request, e.g., API=Nnef_AFSessionWithQOS, and a seventh identifier for the requested service, e.g., QOSReference, which may be understood to indicate the requested QOS to be applied.

### Action 604

In some embodiments, the further node 114 may receive, in this Action 604, a third response to the sent third request from the at least one of the one or more third nodes 113. For example, if the further node 114 has sent the third request to a NEF, the third response may be an authorization by the NEF of the third request.

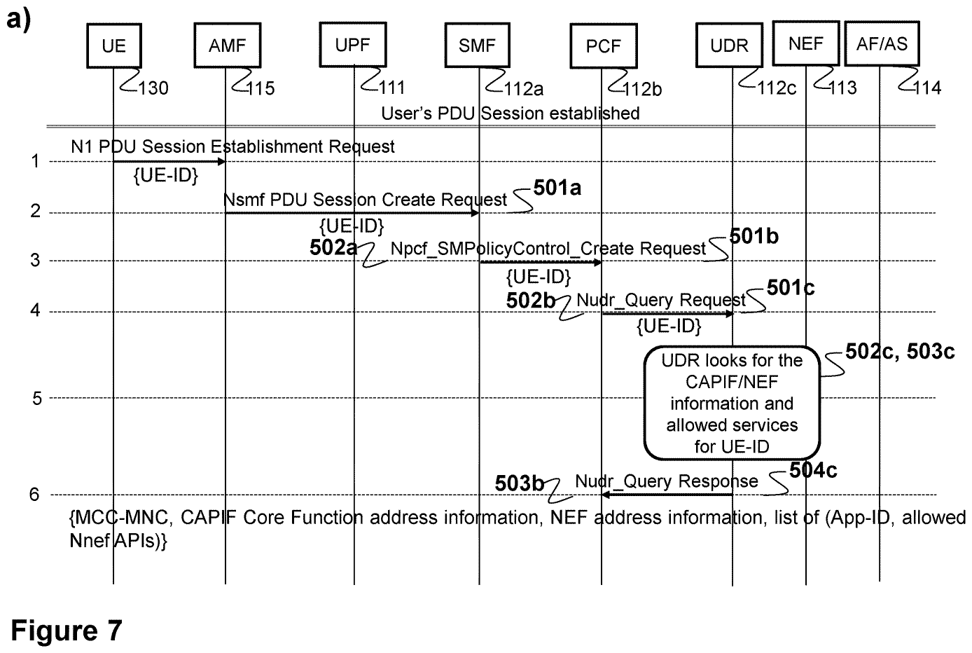

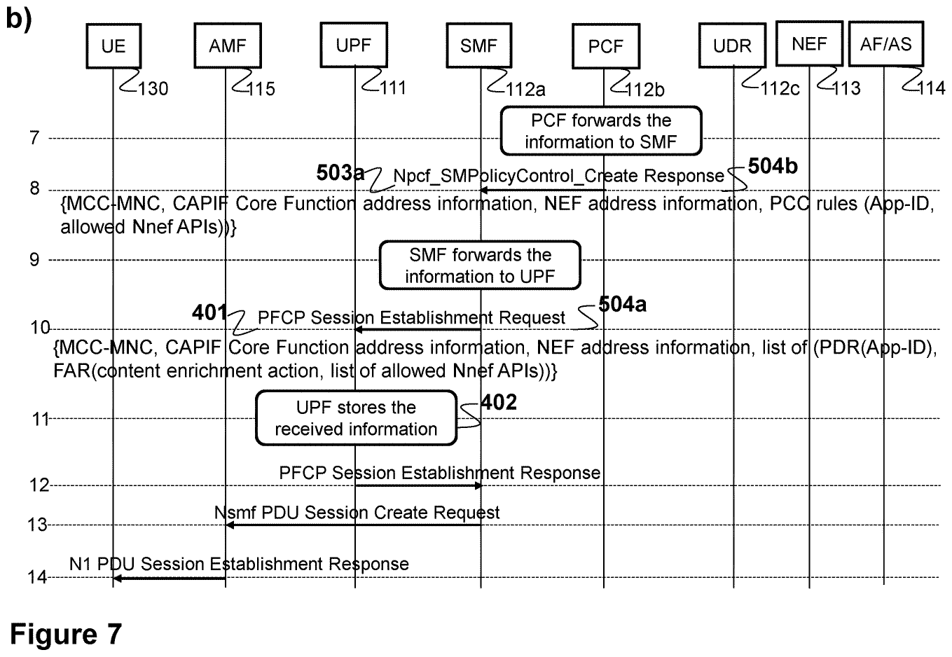

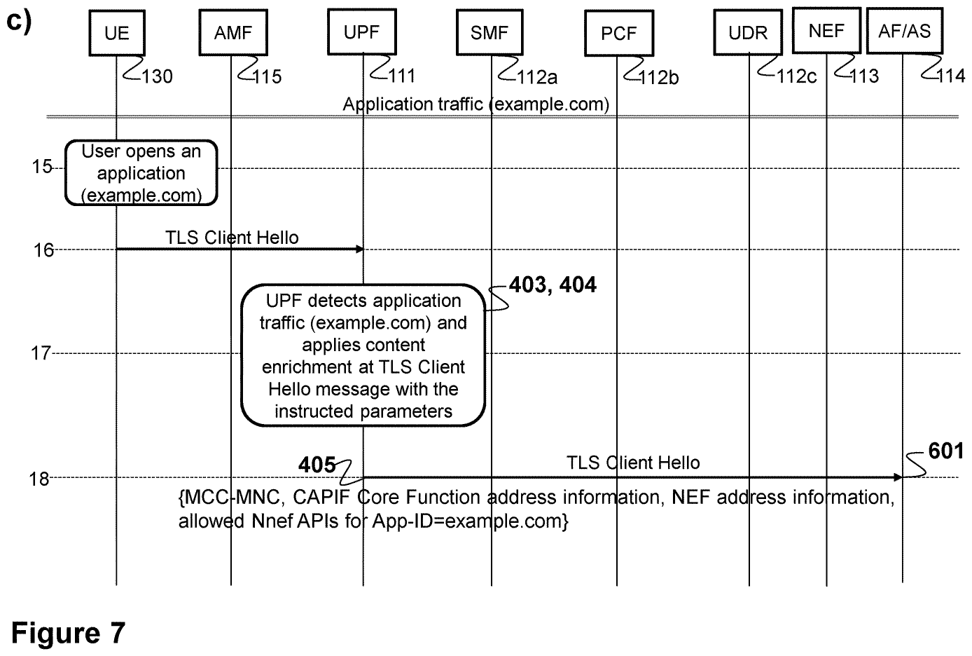

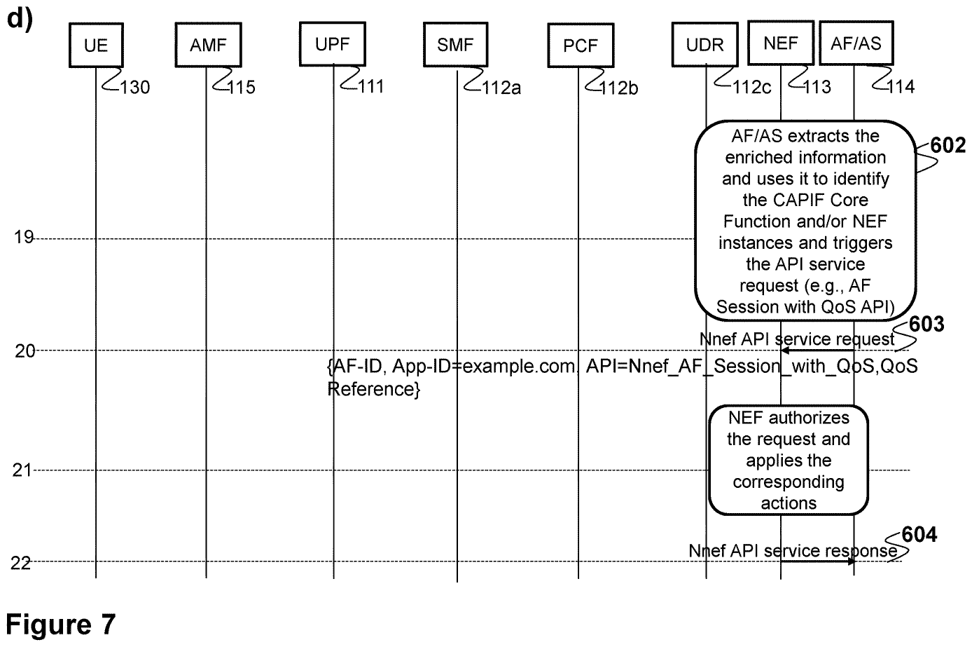

FIG. 7 is a signalling diagram depicting a non-limiting example of a method performed in the communications system 100, according to embodiments herein, over panels a), b), c) and d). In FIG. 7, the communications system 100 is a 5G network, the first node 111 is a UPF, the first second node 112a is an SMF, the second second node 112b is a PCF, the third second node 112c is a UDR, the third node 113 is a NEF, the fourth node 114 is the AF/AS of a content provider, the fifth node 115 is an AMF and the device 130 is a UE. It may be understood that in the following example depicted in FIG. 7, any reference to the UPF may be understood to equally refer to the first node 111, any reference to the SMF may be understood to equally refer to the first second node 112a, any reference to the PCF may be understood to equally refer to the second second node 112b, any reference to the UDR may be understood to equally refer to the third second node 112c, any reference to the NEF may be may be understood to equally refer to the third node 113, any reference to the AF/AS or the content provider may be may be understood to equally refer to the fourth node 114, any reference to the AMF may be may be understood to equally refer to the fifth node 115, and any reference to the UE may be may be understood to equally refer to the device 130. The example of FIG. 7 may be understood to have the following preconditions: the MNO has stored the list of CAPIF Core Function and NEF instances. It is assumed this information is stored in UDR. The MNO has stored the list of available NEF APIs, services, instances. It is assumed this information is stored in UDR. The MNO has stored the list of allowed services both on a per application basis and subscriber basis. It is assumed this is stored in UDR, as subscriber data. Starting on panel a), in Steps 1 to 3), the device 130 triggers a PDU Session Establishment procedure. For simplicity reasons, not all steps are shown. Particularly, in Step 1, the device 130 sends an N1 PDU Session Establishment Request to the fifth node 115, which includes the identifier of the device 130 as UE-ID. In Step 2, the fifth node 115, sends the first request to the first second node 112a, which it receives according to Action 501a. The first request is an Nsmf PDU Session Create Request comprising the identifier of the device 130, the UE-ID. In Step 3, the first second node 112a sends, in accordance with Action 502a and 501b, the first second request to the second second node 112b as an Npcf_SMPolicyControl_Create Request comprising the identifier of the device 130, the UE-ID. In Steps 4 to 6, the second second node 112b, retrieves from the third second node 112b the first information as the session and subscriber data for the device 130, identified for its UE-ID. Particularly, in Step 4, the second second node 112b, in accordance with Action 502b and Action 501c, sends the second second request to the third second node 112c as a Nudr_Query Request comprising the identifier of the device 130, the UE-ID. In Step 5, the third second node 112c, according to Action 502c, sends the third second request to a storage managed by the third second node requesting the first information, here session and subscriber data for the device 130. According to embodiments herein, the session and subscriber data for the device 130 is extended with the following parameters: a) the first identifier as the MCC-MNC, which may be used to identify the MNO, b) the second identifier as the CAPIF Core Function address information, which may be e.g., a domain name, server name or host name, or an IP address which may allow to identify the CAPIF Core Function instance for the user's PDU session, c) the third identifier as the NEF address information, which may be e.g., a domain name, server name or host name, or an IP address which may allow to identify the NEF instance for the user's PDU session, and optionally, d) the one or more respective fourth identifiers as the List of (App-ID, allowed Nnef APIs). This may be understood to be the list of allowed Nnef APIs on a per application basis. For example, for App-ID=example. com, the following services may be allowed for the subscriber: i) QoS service (Nnef_AFsessionWithQoS service), so the further node 114 may be allowed to request a certain QoS for the application, and ii) Sponsoring service (Nnef_ChargeableParty service), so the application data may be allowed to be sponsored by a third party, e.g., the fourth node 114, so it may not be deducted from subscriber's monthly quota. Not shown in the sequence diagram example in FIG. 7, but in order to support dynamic SLA creation, when there may be no explicit SLA between MNO and the fourth node 114, a list of default Nnef APIs for applications which may be unknown to the MNO, e.g., e.g., App-ID=default, may be provisioned. In this case, the further node 114 may also provide the detection rules for those application/s to the MNO. According to the foregoing, in Step 5, the third second node 112c looks for the CAPIF/NEF information and allowed services for the device 130 identified by its UE-ID, and according to Action 503c, retrieves the first information. In Step 6, the third second node 112c, in accordance with Action 504c and 503c, provides the first information to the second second node 112b, by sending the second second response as a Nudr_Query Response comprising the first identifier as the MCC-MNC, the second identifier as the CAPIF Core Function address information, the third identifier as the NEF address information, and the one or more respective fourth identifiers as the list of (App-ID, allowed Nnef APIs). Continuing in panel b) of FIG. 7, in Steps 7 and 8, the second second node 112b, in accordance with Action 504b, forwards to the first second node 112a, the first information retrieved in Step 6 above. Particularly, the second second node 112b sends the first second response as a Npcf_SMPolicyControl_Create Response comprising the first identifier as the MCC-MNC, the second identifier as the CAPIF Core Function address information, the third identifier as the NEF address information, and PCC rules indicating the one or more respective fourth identifiers as the list of (App-ID, allowed Nnef APIs). The N7 interface may be extended according to embodiments herein, e. g, to carry the second identifier as CAPIF Core Function address information, the third identifier as NEF address information and by extending the PCC rule to include the one or more respective fourth identifiers as the allowed Nnef APIs on a per application basis. In Steps 9 and 10, the first second node 112a triggers a PFCP Session Establishment procedure and, in accordance with Action 504a and Action 401, forwards the first information retrieved in step 8 above to the first node 111. Particularly, the first second node 112a sends the first indication as a PFCP Session Establishment Request comprising the first identifier as the MCC-MNC, the second identifier as the CAPIF Core Function address information, the third identifier as the NEF address information, and the further indication instructing the first node 111 to apply content enrichment with the one or more respective fourth identifiers as a list of allowed Nnef APIs, to the second indication that may be received from the device 130, as a list of (PDR(App-ID), FAR(content enrichment action, list of allowed Nnef APIs))}. According to embodiments herein, the N4 interface may be extended, e. g, to carry the second identifier as the CAPIF Core Function address information, the third identifier as the NEF address information and by indicating in the FAR the content enrichment action with the allowed Nnef APIs on a per application basis. In Step 11, the first node 111 stores the received first information, in accordance with Action 402. In Step 12, the first node 111 answers the first second node 112a with a PFCP Session Establishment Response message indicating successful operation. In Step 13, the first second node 112a answers the message in Step 2 by triggering a Nsmf PDU Session Create Response message. In Step 14, the fifth node 115 answers the message in Step 1 by triggering a N1 PDU Session Establishment Response message. Continuing on panel c), in Steps 15 and 16, a user the device 130 opens an application, e.g., example. com. In Steps 17 and 18, the first node 111, in accordance with Action 403, detects application traffic, from example. com, and, in accordance with Action 404, applies content enrichment at the first TLS Client Hello message with the instructed parameters received in Step 10, including the first identifier as the MCC-MNC, the second identifier as the CAPIF Core Function address information, the third identifier as the NEF address information, and the one or more respective fourth identifiers as the allowed services for App-ID=example. com, e.g., the Nnef_ChargeableParty service and the Nnef_AFsessionWithQoS service. The first node 111, then in Step 18, sends, in accordance with Action 405 and Action 601, the first information to the further node 114 as the third indication as the second TLS Client Hello message enriched with the MCC-MNC, the second identifier as the CAPIF Core Function address information, the third identifier as the NEF address information, and the one or more respective fourth identifiers as the allowed services for App-ID=example. com, e.g., the Nnef_ChargeableParty service and the Nnef_AFsessionWithQoS service. Continuing on panel c), in Steps 19 and 20, the further node 114 extracts the enriched information and, in accordance with Action 602, uses it to identify the CAPIF Core Function and/or NEF instances and to trigger the API service request, e.g., AF Session with QOS API. In this example, the further node 114 uses the NEF address information to identify the NEF instance and, in accordance with Action 603, triggers the Nnef API service request to request a certain QoS for the application traffic through Nnef_AFSessionWithQOS API, by including the following information: the sixth identifier of the further node 114, its AF-ID, the fifth identifier identifying the application to which the session belongs, here, App-ID=example. com, the third request, e.g., API=Nnef_AFSessionWithQOS, and the seventh identifier for the requested service, e.g., QoSReference, which may be understood to indicate the requested QoS to be applied. In Steps 21 and 22, the third node 113, here the NEF, authorizes the request and sends, in accordance with Action 604, the third response as a Nnef API service response, and applies the corresponding actions. In this example, the NEF triggers towards the second second node 112b a request for a certain QoS for the application session of the subscriber. This is not shown in the sequence diagram of FIG. 7, as it is based on existing procedures.

Certain embodiments disclosed herein may provide one or more of the following technical advantage(s), which may be summarized as follows.

Embodiments herein may be understood to enable exposing the service offerings a network may have, to applications and services without prior knowledge of what the network may be able to offer. Embodiments herein may be understood to enable technologies such as dynamic SLA creation, intent creation. Embodiments herein may be understood to address the problems of deploying NEF and network services on the internet when SLAs may not yet be in place between the parties and provide methods to handle such problems.

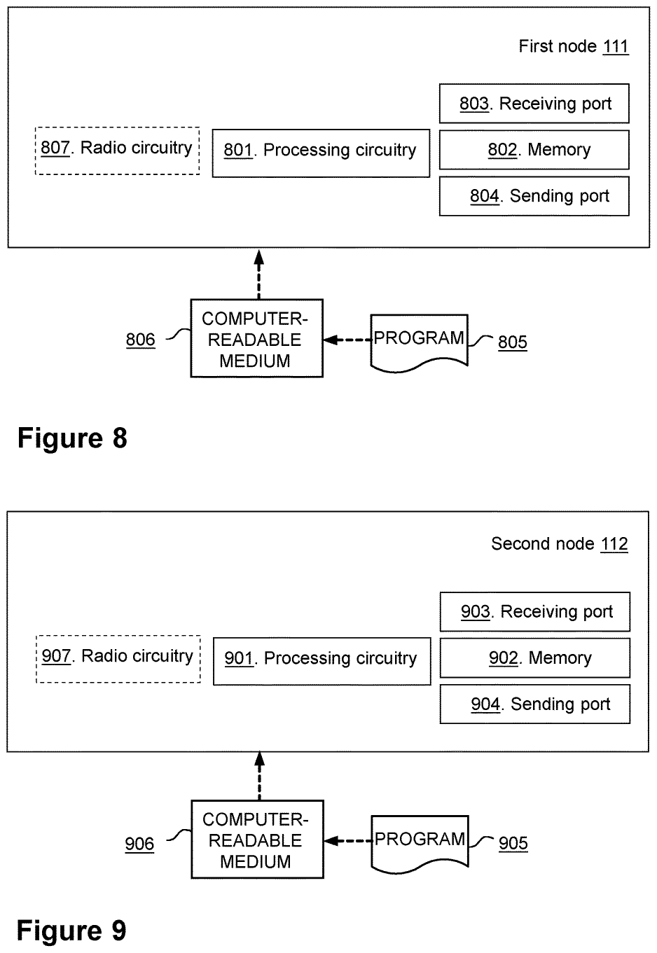

FIG. 8 depicts an example of the arrangement that the first node 111 may comprise to perform the method described in FIG. 4 and/or FIG. 7. The first node 111 may be understood to be for handling the session of the device 130 for the application. The first node 111 and the device 130 are configured to operate in the communications system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the second node 112 may be configured to be a node in the control plane, e.g., 5GC Control Plane, of the communications system 100. The first node 111 may be configured to be a node in the User Plane.

The first node 111 is configured to obtain the first indication from, directly or indirectly, the second node 112 configured to operate in the communications system 100. The first indication is configured to comprise the first information configured to enable to identify the one or more third nodes 113 configured to operate in the communications system 100. The one or more third nodes 113 are configured to expose the services of the operator being configured to service the session of the device 130 for the application. The operator is configured to operate in the communications system 100.

The first node 111 is also configured to initiate, responsive to the first indication configured to be obtained, providing the first information to the further node 114 external to the communications system 100. The further node 114 is configured to service the device 130 in the session for the application.

In some embodiments, the first information may be configured to comprise at least one of: a) the first identifier of the operator, b) the second identifier of the first third node 113a of the one or more third nodes 113, wherein the first third node 113a may be configured to be the CAPIF core function for the session, c) the third identifier of the second third node 113b of the one or more third nodes 113, wherein the second third node 113b may be configured to be one of: i) the NEF instance configured to handle the session, and ii) the SCEF instance configured to handle the session, and d) the one or more respective fourth identifiers of available APIs for the session.

In some embodiments, at least one of the following may apply: a) the first identifier may be configured to be the MNC-MCC, b) the second identifier may be configured to be the first address of the CAPIF Core Function Instance, c) the third identifier may be configured to be the second address of the NEF Instance, and d) the one or more respective fourth identifiers may be configured to comprise the list of Nnef available APIs.

In some embodiments, the first node 111 may be also configured to store the first information configured to be obtained. In such embodiments, the initiating providing may be configured to comprise providing the first information configured to be stored to the further node 114.

In some embodiments, the first node 111 may be also configured to detect, after having received the first indication, traffic from the device 130, by receiving the second indication from the device 130.

In some embodiments, the first node 111 may be also configured to apply content enrichment to the second indication configured to be received, with the first information. In such embodiments, the initiating providing may be configured to comprise sending the third indication configured to comprise the second indication with the applied content enrichment.

In some embodiments. at least one of the following may apply: a) the first indication may be configured to be a PFCP Session Establishment Request, b) the first indication may be further configured to comprise the further indication configured to instruct the first node 111 to perform the applying of the content enrichment, c) the further indication may be configured to be a FAR, d) the second indication may be configured to be a first TLS message, and the third indication may be configured to be a second TLS message, e) the first TLS message may be configured to be a first client Hello message and the second TLS message may be configured to be a second client Hello message, f) the first information may be configured to comprise one of: a) the first identifier and the second identifier, and b) the first identifier and the third identifier, and g) the further indication may be configured to comprise the one or more respective fourth identifiers and the fifth identifier configured to identify the application to which the session may belong.

In some embodiments, one of the following two options may apply. According to a first option, the communications system 100 may be configured to be a 5G, system, the first node 111 may be configured to be a UPF, the further node 114 may be configured to be an AS, or an AF, and the second node 112 may be configured to be a node configured to handle a control plane of the session. The second node 112 may be configured to be at least one of: i) an SMF, ii) a PCF, and iii) a UDR. According to a second option, the communications system 100 may be configured to be a 4G system, the first node 111 may be configured to be a PGW-U, or a TDF-U, the further node 114 may be configured to be an AS, or an SCS and the second node 112 may be configured to be a node configured to handle the control plane of the session. The second node 112 may be configured to be at least one of: i) a PGW-C, or a TDF-C, ii) a PCRF, and iii) an SPR.

The embodiments herein in the first node 111 may be implemented through one or more processors, such as a processing circuitry 801 in the first node 111 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 802 comprising one or more memory units. The memory 802 is arranged to be used to store obtained information, store data, configurations, schedulings, and applications etc. to perform the methods herein when being executed in the first node 111.

In some embodiments, the first node 111 may receive information from, e.g., the second node 112, the first second node 112a, the second second node 112b, the third second node 112c, the one or more third nodes 113, the further node 114, the fifth node 115, the radio network node 140, the device 130, another node, and/or another structure in the communications system 100, through a receiving port 803. In some embodiments, the receiving port 803 may be, for example, connected to one or more antennas in first node 111. In other embodiments, the first node 111 may receive information from another structure in the communications system 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the first node 111 may be further configured to transmit or send information to e.g., the second node 112, the first second node 112a, the second second node 112b, the third second node 112c, the one or more third nodes 113, the further node 114, the fifth node 115, the radio network node 140, the device 130, another node, and/or another structure in the communications system 100, through a sending port 804, which may be in communication with the processing circuitry 801, and the memory 802.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 801.

Thus, the methods according to the embodiments described herein for the first node 111 may be respectively implemented by means of a computer program 805 product, comprising instructions, i.e., software code portions, which, when executed on at least one processing circuitry 801, cause the at least one processing circuitry 801 to carry out the actions described herein, as performed by the first node 111. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the first node 111. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The first node 111 may comprise a communication interface configured to facilitate, or an interface unit to facilitate, communications between the first node 111 and other nodes or devices, e.g., the second node 112, the first second node 112a, the second second node 112b, the third second node 112c, the one or more third nodes 113, the further node 114, the fifth node 115, the radio network node 140, the device 130, another node, and/or another structure in the communications system 100. The interface may, for example, include a transceiver configured to transmit and receive radio signals over an air interface in accordance with a suitable standard.

In other embodiments, the first node 111 may comprise a radio circuitry 807, which may comprise e.g., the receiving port 803 and the sending port 804.

The radio circuitry 807 may be configured to set up and maintain at least a wireless connection with the second node 112, the first second node 112a, the second second node 112b, the third second node 112c, the one or more third nodes 113, the further node 114, the fifth node 115, the radio network node 140, the device 130, another node, and/or another structure in the communications system 100. Circuitry may be understood herein as a hardware component.

Hence, embodiments herein also relate to the first node 111 operative to operate in the communications system 100. The first node 111 may comprise the processing circuitry 801 and the memory 802, said memory 802 containing instructions executable by said processing circuitry 801, whereby the first node 111 is further operative to perform the actions described herein in relation to the first node 111, e.g., in FIG. 4 and/or FIG. 7.

FIG. 9 depicts an example of the arrangement that the second node 112 may comprise to perform the method described in FIG. 5 and/or FIG. 7. The second node 112 may be understood to be for handling the session of the device 130 for the application. The second node 112 and the device 130 are configured to operate in the communications system 100.

Several embodiments are comprised herein. It should be noted that the examples herein are not mutually exclusive. One or more embodiments may be combined, where applicable. All possible combinations are not described to simplify the description.

Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 111 and will thus not be repeated here. For example, in some embodiments, the second node 112 may be configured to be a node in the control plane, e.g., 5GC Control Plane, of the communications system 100. The first node 111 may be configured to be a node in the User Plane.

The second node 112 is configured to obtain the first information configured to enable to identify the one or more third nodes 113 configured to operate in the communications system 100. The one or more third nodes 113 are configured to expose the services of the operator configured to service the session of the device 130 for the application. The operator is configured to operate in the communications system 100.

The second node 112 is also configured to initiate providing, via the first node 111 configured to operate in the communications system 100, the first information towards the further node 114 external to the communications system 100. The first node 111 and the further node 114 are configured to service the device 130 in the session for the application.

In some embodiments, the first information may be configured to comprise at least one of: a) the first identifier of the operator, b) the second identifier of the first third node 113a of the one or more third nodes 113, wherein the first third node 113a may be configured to be the CAPIF core function for the session, c) the third identifier of the second third node 113b of the one or more third nodes 113, wherein the second third node 113b may be configured to be one of: i) the NEF instance configured to handle the session, and ii) the SCEF instance configured to handle the session, and d) the one or more respective fourth identifiers of available APIs for the session.

In some embodiments, at least one of the following may apply: a) the first identifier may be configured to be the MNC-MCC, b) the second identifier may be configured to be the first address of the CAPIF Core Function Instance, c) the third identifier may be configured to be the second address of the NEF Instance, d) the one or more respective fourth identifiers may be configured to comprise the list of Nnef available APIs, and e) the first information may be configured to comprise one of: a) the first identifier and the second identifier, and b) the first identifier and the third identifier.

In some embodiments, one of the following two options may apply. According to the first option, the communications system 100 may be configured to be the 5G system, the first node 111 may be configured to be the UPF, the further node 114 may be configured to be the AS, or the AF, and the second node 112 may be configured to be the node configured to handle the control plane of the session. The second node 112 may be configured to be at least one of: i) the SMF, ii) the PCF, and iii) the UDR. According to the second option, the communications system 100 may be configured to be the 4G system, the first node 111 may be configured to be the PGW-U, or the TDF-U, the further node 114 may be configured to be the AS, or the SCS and the second node 112 may be configured to be the node configured to handle the control plane of the session. The second node 112 may be configured to be at least one of: i) the PGW-C, or the TDF-C, ii) the PCRF, and iii) the SPR.

In some embodiments, the second node 112 may be further configured to receive the first request from another node 111, 115, 112a, 112b. The first request may be configured to trigger the obtaining of the first information.

In some embodiments, the second node 112 may be further configured to send, based on the first request configured to be received, the second request to obtain, directly or indirectly, the first information. The obtaining of the first information may be configured to be obtained in the first response to the second request configured to be sent.

In some embodiments, the second node 112 may be configured to be the first second node 112a. In some of such embodiments, at least one of the following may apply: a) the first request may be configured to be the first first request received from the fifth node 115 configured to operate in the communication system 100, b) the first first request may be configured to establish the session for the device 130, c) the first first request may be configured to comprise the identifier of the device 130, d) the first second node 112a may be configured to be the SMF, e) the fifth node 115 may be configured to be the AMF, f) the first first request may be configured to be the Nsmf PDU Session Create Request, g) the second request may be configured to be the first second request configured to be sent to the second second node 112b, h) the second second node 112 b may be configured to be the PCF, i) the first second request may be configured to be the Npcf_SMPolicyControl_Create Request, j) the first response may be configured to be the first first response from the second second node 112b, k) the first first response may be configured to be the Npcf_SMPolicyControl_Create Response, I) the first node 111 may be configured to be the UPF, m) the initiating providing may be configured to comprise sending the first information to the first node 111 in the first indication, n) the first indication may be configured to be the PFCP Session Establishment Request, o) the first indication may be configured to further comprise the further indication configured to instruct the first node 111 to apply content enrichment to the second indication configured to be received from the device 130, p) the further indication may be configured to be the FAR, q) the second indication may be configured to be the TLS, message, and r) the first TLS message may be configured to be the first client Hello message.

In some embodiments, the second node 112 may be configured to be the second second node 112b. In some of such embodiments, at least one of the following may apply: a) the first request may be configured to be the second first request configured to be received from the first second node 112a, b) the second first request may be configured to be for the policy control for the session, c) the second first request may be configured to comprise the identifier of the device 130, d) the second second node 112b may be configured to be the PCF, e) the first second node 112a may be configured to be the SMF, f) the second first request may be configured to be the Npcf_SMPolicyControl_Create Request, g) the second request may be configured to be the second second request configured to be sent to the third second node 112c, h) the third second node 112 c may be configured to be the UDR, i) the second second request may be configured to be the Nudr_Query Request, j) the first response may be configured to be the second first response from the third second node 112c, k) the second first response may be configured to be the Nudr_Query Response, I) the first node 111 may be configured to be the UPF, m) the initiating providing may be configured to comprise sending the first information to the first second node 112a in the first second response, and n) the second response may be configured to be the Npcf_SMPolicyControl_Create Response.

the second node 112 may be configured to be the third second node 112c. In some of such embodiments, at least one of the following may apply: a) the first request may be configured to be the third first request configured to be received from the second second node 112b, b) the third first request may be configured to be for subscriber data for the device 130, c) the third first request may be configured to comprise the identifier of the device 130, d) the third second node 112c may be configured to be the UDR, e) the second second node 112b may be configured to be the PCF, f) the third first request may be configured to be the Nudr_Query Request, g) the second request may be configured to be the third second request to the storage configured to be managed by the third second node 112c, h) the first response may be configured to be the third first response from the storage, i) the first node 111 may be configured to be the UPF, j) the initiating providing may be configured to comprise sending the first information to the second second node 112b in the second second response, and k) the second second response may be configured to be the Nudr_Query Response.

The embodiments herein in the second node 112 may be implemented through one or more processors, such as a processing circuitry 901 in the second node 112 depicted in FIG. 9, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 902 comprising one or more memory units. The memory 902 is arranged to be used to store obtained information, store data, configurations, schedulings, and applications etc. to perform the methods herein when being executed in the second node 112.

In some embodiments, the second node 112 may receive information from, e.g., the first node 111, another second second node 112, the first second node 112a, the second second node 112b, the third second node 112c, the one or more third nodes 113, the further node 114, the fifth node 115, the radio network node 140, the device 130, another node, and/or another structure in the communications system 100, through a receiving port 903. In some embodiments, the receiving port 903 may be, for example, connected to one or more antennas in second node 112. In other embodiments, the second node 112 may receive information from another structure in the communications system 100 through the receiving port 903. Since the receiving port 903 may be in communication with the processing circuitry 901, the receiving port 903 may then send the received information to the processing circuitry 901. The receiving port 903 may also be configured to receive other information.

The processing circuitry 901 in the second node 112 may be further configured to transmit or send information to e.g., the first node 111, another second second node 112, the first second node 112a, the second second node 112b, the third second node 112c, the one or more third nodes 113, the further node 114, the fifth node 115, the radio network node 140, the device 130, another node, and/or another structure in the communications system 100, through a sending port 904, which may be in communication with the processing circuitry 901, and the memory 902.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 901, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 901.

Thus, the methods according to the embodiments described herein for the second node 112 may be respectively implemented by means of a computer program 905 product, comprising instructions, i.e., software code portions, which, when executed on at least one processing circuitry 901, cause the at least one processing circuitry 901 to carry out the actions described herein, as performed by the second node 112. The computer program 905 product may be stored on a computer-readable storage medium 906. The computer-readable storage medium 906, having stored thereon the computer program 905, may comprise instructions which, when executed on at least one processing circuitry 901, cause the at least one processing circuitry 901 to carry out the actions described herein, as performed by the second node 112. In some embodiments, the computer-readable storage medium 906 may be a non-transitory computer-readable storage medium, such as a CD ROM disc, or a memory stick. In other embodiments, the computer program 905 product may be stored on a carrier containing the computer program 905 just described, wherein the carrier is one of an electronic signal, optical signal, radio signal, or the computer-readable storage medium 906, as described above.

The second node 112 may comprise a communication interface configured to facilitate, or an interface unit to facilitate, communications between the second node 112 and other nodes or devices, e.g., the first node 111, another second second node 112, the first second node 112a, the second second node 112b, the third second node 112c, the one or more third nodes 113, the further node 114, the fifth node 115, the radio network node 140, the device 130, another node, and/or another structure in the communications system 100. The interface may, for example, include a transceiver configured to transmit and receive radio signals over an air interface in accordance with a suitable standard.

In other embodiments, the second node 112 may comprise a radio circuitry 907, which may comprise e.g., the receiving port 903 and the sending port 904.

The radio circuitry 907 may be configured to set up and maintain at least a wireless connection with the first node 111, another second second node 112, the first second node 112a, the second second node 112b, the third second node 112c, the one or more third nodes 113, the further node 114, the fifth node 115, the radio network node 140, the device 130, another node, and/or another structure in the communications system 100. Circuitry may be understood herein as a hardware component.

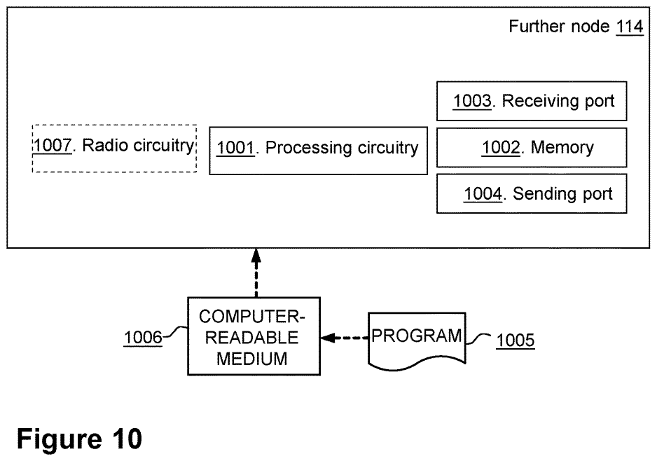

Hence, embodiments herein also relate to the second node 112, operative to operate in the communications system 100. The second node 112 may comprise the processing circuitry 901 and the memory 902, said memory 902 containing instructions executable by said processing circuitry 901, whereby the second node 112 is further operative to perform the actions described herein in relation to the second node 112, e.g., in FIG. 5 and/or FIG. 7. FIG. 10 depicts an example of the arrangement that the further node 114 may comprise to perform the method described in FIG. 6 and/or FIG. 7. The further node 114 is configured to be accessible via the communications system 100. The further node 114 may be understood to be for handling the session of the device 130 configured to operate in the communications system 100, for the application. The further node 114 is configured to be external to the communications system 100. The further node 114 is configured to service the device 130 in the session for the application.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the further node 114 and will thus not be repeated here. For example, in some embodiments, the second node 112 may be configured to be a node in the control plane, e.g., 5GC Control Plane, of the communications system 100. The first node 111 may be configured to be a node in the User Plane.

The further node 114 is configured to obtain the first information from the first node 111 configured to operate in the communications system 100. The first information is configured to enable to identify the one or more third nodes 113 configured to operate in the communications system 100. The one or more third nodes 113 are configured to expose the services of the operator configured to service the session of the device 130 for the application. The operator is configured to operate in the communications system 100.

The further node 114 is also configured to determine, responsive to the first information configured to be obtained, the identity of the one or more third nodes 113.

The further node 114 is further configured to initiate sending the third request for the service, for the session application, to at least one of the one or more third nodes 113 configured to be identified.

In some embodiments, the first information may comprise at least one of: a) the first identifier of the operator, b) the second identifier of the first third node 113a of the one or more third nodes 113, wherein the first third node 113a may be configured to be the CAPIF core function for the session, c) the third identifier of the second third node 113b of the one or more third nodes 113, wherein the second third node 113b may be configured to be one of: i) the NEF instance configured to handle the session, and ii) the SCEF instance configured to handle the session, and d) the one or more respective fourth identifiers of available APIs for the session.

In some embodiments, at least one of the following may apply: a) the first identifier may be configured to be the MNC-MCC, b) the second identifier may be configured to be the first address of the CAPIF Core Function Instance, c) the third identifier may be configured to be the second address of the NEF Instance, and d) the one or more respective fourth identifiers may be configured to comprise the list of Nnef available APIs.

In some embodiments, at least one of the following may apply: a) the obtaining of the first information may be configured to comprise receiving the third indication configured to comprise the second indication with content enrichment, b) the determining of the identity may be configured to comprise extracting the content enrichment from the third indication, c) the second indication may be configured to be the TLS message, and the third indication may be configured to be the second TLS message, d) the first TLS message may be configured to be the first client Hello message and the second TLS message may be configured to be the second client Hello message, and e) the first information may be configured to comprise the one of: a) the first identifier and the second identifier, and b) the first identifier and the third identifier.

In some embodiments, the further node 114 may be further configured to receive the third response to the sent third request from the at least one of the one or more third nodes 113.

In some embodiments, one of the following two options may apply. According to the first option, the communications system 100 may be configured to be the 5G system, the first node 111 may be configured to be the UPF, and the further node 114 may be configured to be the AS, or the AF. According to the second option, the communications system 100 may be configured to be the 4G system, the first node 111 may be configured to be the PGW-U, or the TDF-U, and the further node 114 may be configured to be the AS, or the SCS.

The embodiments herein in the further node 114 may be implemented through one or more processors, such as a processing circuitry 1001 in the further node 114 depicted in FIG. 10, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the further node 114. One such carrier may be in the form of a CD ROM disc. It is however feasible with other data carriers such as a memory stick. The computer program code may furthermore be provided as pure program code on a server and downloaded to the further node 114.

The further node 114 may further comprise a memory 1002 comprising one or more memory units. The memory 1002 is arranged to be used to store obtained information, store data, configurations, schedulings, and applications etc. to perform the methods herein when being executed in the further node 114.

In some embodiments, the further node 114 may receive information from, e.g., the first node 111, the second node 112, the first second node 112a, the second second node 112b, the third second node 112c, the one or more third nodes 113, the fifth node 115, the radio network node 140, the device 130, another node, and/or another structure in the communications system 100, through a receiving port 1003. In some embodiments, the receiving port 1003 may be, for example, connected to one or more antennas in further node 114. In other embodiments, the further node 114 may receive information from another structure in the communications system 100 through the receiving port 1003. Since the receiving port 1003 may be in communication with the processing circuitry 1001, the receiving port 1003 may then send the received information to the processing circuitry 1001. The receiving port 1003 may also be configured to receive other information.

The processing circuitry 1001 in the further node 114 may be further configured to transmit or send information to e.g., the first node 111, the second node 112, the first second node 112a, the second second node 112b, the third second node 112c, the one or more third nodes 113, the fifth node 115, the radio network node 140, the device 130, another node, and/or another structure in the communications system 100, through a sending port 1004, which may be in communication with the processing circuitry 1001, and the memory 1002.

Those skilled in the art will also appreciate that the units comprised within the further node 114 described above as being configured to perform different actions, may refer to a combination of analog and digital circuits, and/or one or more processors configured with software and/or firmware, e.g., stored in memory, that, when executed by the one or more processors such as the processing circuitry 1001, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the further node 114 described above as being configured to perform different actions described above may be implemented as one or more applications running on one or more processors such as the processing circuitry 1001.

Thus, the methods according to the embodiments described herein for the further node 114 may be respectively implemented by means of a computer program 1005 product, comprising instructions, i.e., software code portions, which, when executed on at least one processing circuitry 1001, cause the at least one processing circuitry 1001 to carry out the actions described herein, as performed by the further node 114. The computer program 1005 product may be stored on a computer-readable storage medium 1006. The computer-readable storage medium 1006, having stored thereon the computer program 1005, may comprise instructions which, when executed on at least one processing circuitry 1001, cause the at least one processing circuitry 1001 to carry out the actions described herein, as performed by the further node 114. In some embodiments, the computer-readable storage medium 1006 may be a non-transitory computer-readable storage medium, such as a CD ROM disc, or a memory stick. In other embodiments, the computer program 1005 product may be stored on a carrier containing the computer program 1005 just described, wherein the carrier is one of an electronic signal, optical signal, radio signal, or the computer-readable storage medium 1006, as described above.

The further node 114 may comprise a communication interface configured to facilitate, or an interface unit to facilitate, communications between the further node 114 and other nodes or devices, e.g., the first node 111, the second node 112, the first second node 112a, the second second node 112b, the third second node 112c, the one or more third nodes 113, the fifth node 115, the radio network node 140, the device 130, another node, and/or another structure in the communications system 100. The interface may, for example, include a transceiver configured to transmit and receive radio signals over an air interface in accordance with a suitable standard.

In other embodiments, the further node 114 may comprise a radio circuitry 1007, which may comprise e.g., the receiving port 1003 and the sending port 1004.

The radio circuitry 1007 may be configured to set up and maintain at least a wireless connection with the first node 111, the second node 112, the first second node 112a, the second second node 112b, the third second node 112c, the one or more third nodes 113, the fifth node 115, the radio network node 140, the device 130, another node, and/or another structure in the communications system 100. Circuitry may be understood herein as a hardware component.

Hence, embodiments herein also relate to the further node 114, operative to operate in the communications system 100. The further node 114 may comprise the processing circuitry 1001 and the memory 1002, said memory 1002 containing instructions executable by said processing circuitry 1001, whereby the further node 114 is further operative to perform the actions described herein in relation to the further node 114, e.g., in FIG. 6 and/or FIG. 7.

Embodiments herein may also comprise the communications system 100 comprising the first node 111 configured as described in relation to FIG. 8, a second node 112 configured as described in relation to FIG. 9, and a further node 114 configured as described in relation to FIG. 10.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. 3GPP TS 23.222 v 17.7.0 (Sept 2022): Common API Framework for 3GPP Northbound APIs

1. A computer-implemented method, performed by a first node, for handling a session of a device for an application, the first node and the device operating in a communications system, the method comprising:
obtaining a first indication from, directly or indirectly, a second node operating in the communications system, the first indication comprising first information enabling to identify one or more third nodes operating in the communications system, the one or more third nodes exposing services of an operator servicing the session of the device for the application, the operator operating in the communications system; and
initiating, responsive to the obtained first indication, providing the first information to a further node external to the communications system, the further node servicing the device in the session for the application.

2. The method according to claim 1, wherein the first information comprises at least one of:
a first identifier of the operator;
a second identifier of a first third node of the one or more third nodes, wherein the first third node is a Common Application Programming Interface Framework, CAPIF, core function for the session;
a third identifier of a second third node of the one or more third nodes, wherein the second third node is one of:
a Network Exposure Function, NEF, instance handling the session; and
a Service Capability Exposure Function, SCEF, instance handling the session; and
one or more respective fourth identifiers of available Application Programming Interfaces, APIs, for the session.

3. The method according to claim 2, wherein at least one of:
the first identifier is a Mobile Network Code-Mobile Country Code, MNC-MCC;
the second identifier is a first address of a CAPIF Core Function Instance;
the third identifier is a second address of the NEF Instance; and
the one or more respective fourth identifiers comprise a list of Nnef available APIs.

4. The method according to claim 1, further comprising at least one of:
storing the obtained first information, and wherein the initiating providing comprises providing the stored first information to the further node;
detecting, after having received the first indication, traffic from the device, by receiving a second indication from the device; and
applying content enrichment to the received second indication with the first information, and wherein the initiating providing comprises sending a third indication comprising the second indication with the applied content enrichment.

5. The method according to claim wherein at least one of:
the first indication is a Packet Flow Control Protocol, PFCP, Session Establishment Request;
the first indication further comprises a further indication instructing the first node to perform the applying of the content enrichment;
the further indication is a Forwarding Action Rule;
the second indication is a first Transport Layer Security, TLS, message, and the third indication is a second TLS message;
the first TLS message is a first client Hello message and the second TLS message is a second client Hello message;
the first information comprises one of: a) the first identifier and the second identifier, and b) the first identifier and the third identifier; and
the further indication comprises the one or more respective fourth identifiers and a fifth identifier identifying the application to which the session belongs.

6. The method according to claim 1, wherein one of:
the communications system is a Fifth Generation, 5G, system, the first node is a User Plane Function, UPF, the further node is an Application Server, AS, or an Application Function, AF, and the second node is a node handling a control plane of the session, wherein the second node is at least one of:
a Session Management Function, SMF;
a Policy Control Function, PCF; and
a User Data Repository, UDR; and
the communications system is a Fourth Generation, 4G, system, the first node is a Packet Data Network Gateway User Plane Function, PGW-U, or a Traffic Detection Function User Plane, TDF-U, the further node is an Application Server, AS, or a Service Capability Service, SCS and the second node is a node handling a control plane of the session, wherein the second node is at least one of: <a Packet Data Network Gateway Control Plane Function, PGW-C, or a Traffic Detection Function Control Plane, TDF-C;
a Policy and Charging Rule Function, PCRF; and
a Subscriber Profile Repository, SPR.

7. A computer-implemented method, performed by a second node, for handling a session of a device for an application, the second node and the device operating in a communications system, the method comprising:
obtaining first information enabling to identify one or more third nodes operating in the communications system, the one or more third nodes exposing services of an operator servicing the session of the device for the application, the operator operating in the communications system; and
initiating providing, via a first node operating in the communications system, the first information towards a further node external to the communications system, the first node and the further node servicing the device in the session for the application.

8. The method according to claim 7, wherein the first information comprises at least one of:
a first identifier of the operator;
a second identifier of a first third node of the one or more third nodes, wherein the first third node is a Common Application Programming Interface Framework, CAPIF, core function for the session;
a third identifier of a second third node of the one or more third nodes wherein the second third node is one of:
a Network Exposure Function, NEF, instance handling the session; and
a Service Capability Exposure Function, SCEF, instance handling the session; and
one or more respective fourth identifiers of available Application Programming Interfaces, APIs, for the session.

9. The method according to claim 8, wherein at least one of:
the first identifier is a Mobile Network Code-Mobile Country Code, MNC-MCC;
the second identifier is a first address of a CAPIF Core Network Function Instance,
the third identifier is a second address of a NEF Instance;
the one or more respective fourth identifiers comprise a list of Nnef available APIs; and
the first information comprises one of: a) the first identifier and the second identifier, and b) the first identifier and the third identifier.

10. The method according to claim 7, wherein one of:
the communications system is a Fifth Generation, 5G, system, the first node is a User Plane Function, UPF, the further node is an Application Server, AS, or an Application Function, AF, and the second node is a node handling a control plane of the session, wherein the second node is one of:
a Session Management Function, SMF;
a Policy Control Function, PCF; and
a User Data Repository, UDR; and
the communications system is a Fourth Generation, 4G, system, the first node is a Packet Data Network Gateway User Plane Function, PGW-U, or a Traffic Detection Function User Plane, TDF-U, the further node is an Application Server, AS, or a Service Capability Service, SCS and the second node is a node handling a control plane of the session, wherein the second node is one of:
a Packet Data Network Gateway Control Plane Function, PGW-C, or a Traffic Detection Function Control Plane, TDF-C;
a Policy and Charging Rule Function, PCRF; and
a Subscriber Profile Repository, SPR.

11. The method according to claim 7, wherein the method further comprises at least one of:
receiving a first request from another node the first request triggering the obtaining of the first information; and
sending based on the received first request, a second request to obtain, directly or indirectly, the first information, and wherein the obtaining of the first information is obtained in a first response to the sent second request.

12. The method according to claim 11, wherein the second node is a first second node and wherein at least one of:
the first request is a first first request received from a fifth node operating in the communication system;
the first first request is to establish the session for the device;
the first first request comprises an identifier of the device;
the first second node is an SMF;
the fifth node is an Access and Mobility Function (AMF);
the first first request is an Nsmf PDU Session Create Request;
the second request is a first second request sent to a second second node,
the second second node is a PCF;
the first second request is an Npcf_SMPolicyControl_Create Request;
the first response is a first first response from the second second node;
the first first response is a Npcf_SMPolicyControl_Create Response;
the first node is a UPF;
the initiating providing comprises sending the first information to the first node in a first indication;
the first indication is a Packet Flow Control Protocol, PFCP, Session Establishment Request;
the first indication further comprises a further indication instructing the first node to apply content enrichment to a second indication received from the device;
the further indication is a Forwarding Action Rule;
the second indication is a first Transport Layer Security, TLS, message; and
the first TLS message is a first client Hello message.

13. The method according to claim 11, wherein the second node is a second second node and wherein at least one of:
the first request is a second first request received from a first second node;
the second first request is for a policy control for the session;
the second first request comprises an identifier of the device;
the second second node is a PCF;
the first second node is an SMF;
the second first request is a Npcf_SMPolicyControl_Create Request;
the second request is a second second request sent to a third second node;
the third second node is a UDR;
the second second request is a Nudr_Query Request;
the first response is a second first response from the third second node,
the second first response is a Nudr_Query Response,
the first node is a UPF,
the initiating providing comprises sending the first information to the first second node in a first second response, and
the second response is a Npcf_SMPolicyControl_Create Response.

14. The method according to claim 11, wherein the second node is a third second node and wherein at least one of:
the first request is a third first request received from a second second node;
the third first request is for subscriber data for the device;
the third first request comprises an identifier of the device;
the third second node is an UDR;
the second second node is a PCF;
the third first request is a Nudr_Query Request;
the second request is a third second request to a storage managed by the third second node;
the first response is a third first response from the storage;
the first node is a UPF;
the initiating providing comprises sending the first information to the second second node in a second second response; and
the second second response is a Nudr_Query Response.

15.-20. (canceled)

21. A first node, for handling a session of a device for an application, the first node and the device being configured to operate in a communications system, the first node being further configured to:
obtain a first indication from, directly or indirectly, a second node configured to operate in the communications system, the first indication being configured to comprise first information configured to enable to identify one or more third nodes configured to operate in the communications system, the one or more third nodes being configured to expose services of an operator being configured to service the session of the device for the application, the operator being configured to operate in the communications system, and
initiate, responsive to the first indication configured to be obtained, providing the first information to a further node external to the communications system the further node being configured to service the device in the session for the application.

22. The first node according to claim 21, wherein the first information is configured to comprise at least one of:
a first identifier of the operator;
a second identifier of a first third node of the one or more third nodes wherein the first third node is configured to be a Common Application Programming Interface Framework, CAPIF, core function for the session;
a third identifier of a second third node of the one or more third nodes wherein the second third node is configured to be one of:
a Network Exposure Function, NEF, instance configured to handle the session; and
a Service Capability Exposure Function, SCEF, instance configured to handle the session; and
one or more respective fourth identifiers of available Application Programming Interfaces, APIs, for the session.

23. The first node according to claim 22, wherein at least one of:
the first identifier is configured to be a Mobile Network Code-Mobile Country Code, MNC-MCC;
the second identifier is configured to be a first address of a CAPIF Core Function Instance;
the third identifier is configured to be a second address of the NEF Instance; and
the one or more respective fourth identifiers are configured to comprise a list of Nnef available APIs.

24.-26. (canceled)

27. A second node, for handling a session of a device for an application, the second node and the device being configured to operate in a communications system, the second node being further configured to:
obtain first information configured to enable to identify one or more third nodes configured to operate in the communications system, the one or more third nodes being configured to expose services of an operator configured to service the session of the device for the application, the operator being configured to operate in the communications system, and
initiate providing, via a first node configured to operate in the communications system, the first information towards a further node external to the communications system, the first node and the further node being configured to service the device in the session for the application.

28. The second node according to claim 27, wherein the first information is configured to comprise at least one of:
a first identifier of the operator;
a second identifier of a first third node of the one or more third nodes wherein the first third node is configured to be a Common Application Programming Interface Framework, CAPIF, core function for the session;
a third identifier of a second third node of the one or more third nodes wherein the second third node is configured to be one of:
a Network Exposure Function, NEF, instance configured to handle the session; and
a Service Capability Exposure Function, SCEF, instance configured to handle the session; and
one or more respective fourth identifiers of available Application Programming Interfaces, APIs, for the session.

29. The second node according to claim 28, wherein at least one of:
the first identifier is configured to be a Mobile Network Code-Mobile Country Code, MNC-MCC;
the second identifier is configured to be a first address of a CAPIF Core Network Function Instance;
the third identifier is configured to be a second address of a NEF Instance;
the one or more respective fourth identifiers are configured to comprise a list of Nnef available APIs; and
the first information is configured to comprise one of: a) the first identifier and the second identifier, and b) the first identifier and the third identifier.

30-41. (canceled)
